(19) United States
(12) Patent Application Publication
(10) Pub. No.: US 2006/0281532 A1
(43) Pub. Date: Dec. 14, 2006

(54) Gaming machine

(75) Inventor: Kazumasa Yoshizawa, Tokyo (JP)

Correspondence Address: ARENT FOX PLLC, 1050 CONNECTICUT AVENUE, N.W., SUITE 400, WASHINGTON, DC, 20036, US

(73) Assignee: Aruze Corp.

(21) Appl. No.: 11/448,792

(22) Filed: Jun. 8, 2006

(30) Foreign Application Priority Data
Jun. 10, 2005 (JP) 2005-171403
Jun. 10, 2005 (JP) 2005-171404

(51) Int. Cl. A63F 13/00

(52) U.S. Cl. 463/20

(57) ABSTRACT

A slot machine comprises: reels for variably displaying a plurality of symbols used in a basic game; reels for variably displaying a plurality of symbols used in a bonus game which is played in addition to the basic game; and a lower liquid crystal display disposed in opposition to the both types of reels and for displaying the effects corresponding to the gaming state. When blank symbols contained in the plurality of symbols are displayed by the reels, a CPU causes the lower liquid crystal display to display any of the symbols contained in the plurality of symbols on a position, in the lower liquid crystal display, which corresponds to the blank symbol.

### RELATED APPLICATIONS

This application claims the priority of Japanese Patent Application Nos. 2005-171403 and 2005-171404 filed on Jun. 10, 2005, which are incorporated herein by reference.

### BACKGROUND OF THE INVENTION

1. Field of the Invention

The present invention relates to a gaming machine such as a slot machine, and particularly to a gaming machine for producing an effect using so-called blank symbols.

2. Description of the Prior Art

There has been conventionally proposed a slot machine with new gaming interest, which has a two-layer structure of reels so as to eliminate the defect of the slot machines where games tend to be monotonous because of the contents of an operation in which rotation and display of a reel having a plurality of symbols are stopped to determine winning in accordance with the combination of stopped symbols (see, for example, Japanese Unexamined Patent Publication No. H11-216219).

In such a slot machine, the gaming interest is increased by, for example, showing a symbol on an internal reel through a so-called blank symbol in an external reel, and by changing the type of the symbol by overlapping the symbol on the external reel and the symbol on the internal reel, to eventually increase the types of symbols.

However, in the conventional slot machine described in the abovementioned publication document, the blank symbols are used only when showing a player a symbol on the internal reel, thus the player sometimes feel that the effects using the blank symbols is not enough.

Recently, the preference of a player is diversified rapidly, and at the same time diversification of the effects in the slot machine is required constantly. Under such circumstances, unpredictability in the detail of an effect is required, hence a slot machine which can satisfy such requirements of the player and provide effects using blank symbols is requested.

In the prior art, in order to allow a player to enjoy a game, there is suggested a slot machine comprising, separately from a main reel for presenting a game result to a player, a reel for effects which shows an effect to increase the gaming interest in a game (see, for example, Japanese Unexamined Patent Publication No. 2002-224270). Although this conventional slot machine is provided with the reel for effects in consideration of the importance of the effects, the problem is that the small size of the reel for effects cannot sufficiently increase the gaming interest by using the effects.

Since the reel itself is small, only extremely small number of symbols, such as five, is illustrated on, for example, a circumferential surface of the reel for effects, and thus the number of combinations of symbols is small accordingly, hence only simple effects are provided. Although increasing the size of the reel for effects is conceivable to deal with these problems, it is generally difficult to dispose a large main reel along with a large reel for effects in a cabinet of a slot machine under a circumstance where a display region facing a player is limited.

On the other hand, recently, the preference of a player is diversified rapidly, and at the same time diversification of the effects in the slot machine is required constantly. Under such circumstances, in the production of slot machines, it is conceivable to develop a slot machine which provides effects using a reel which is used specifically in a sub-game played in addition to a basic game.

### SUMMARY OF THE INVENTION

The present invention is contrived in view of such circumstances, and an object thereof is to provide a gaming machine which can increase the gaming interest by effectively utilizing the contents in which blank symbols are used.

Additionally, an object of the present invention is to provide a gaming machine comprising a reel used in a sub-game played in addition to a basic game, the gaming machine being capable of increasing the gaming interest in a sub-game.

In order to achieve the above objects, a gaming machine according to the present invention comprises: display means having a variable display section for variably displaying a plurality of symbols used in a game; and control means for controlling the variable display on the variable display section; wherein when causing the variable display section to display at least one blank symbol, at least one symbol of a group of additional symbols, which are added and displayed on the at least one blank symbol included in the plurality of symbols at least during variable display performed by the variable display section, is added and displayed on the at least one blank symbol by the control means.

Further, a first aspect of the present invention comprises: display means having a variable display section for variably displaying a plurality of symbols used in a game; and control means for controlling the variable display performed by the variable display section; wherein the control means causes the display means to display additional symbol, which is added and displayed on a blank symbol included in the plurality of symbol, at least during the variable display performed by the variable display section when the blank symbol is displayed on the variable display section.

According to the gaming machine related to the first aspect, while the additional symbols, which are added and displayed on the blank symbols during variable display performed by the variable display section, are displayed on the display means, when the blank symbols are displayed on the variable display section the additional symbols are added and displayed on the blank symbols. Accordingly, a player can recognize the additional symbols which are displayed on the blank symbols corresponding originally to the losing in a game. As a result, the player can be allowed to expect a profit from display of the additional symbols on the blank symbols, thus the gaming interest in the game can be increased by effectively utilizing the effects in which the blank symbols are used.

In the gaming machine according to the first aspect, the control means may display a plurality of additional symbols, and display any one of the plurality of additional symbols on a blank symbol when causing the variable display section to display the blank symbol. In this case, any of the plurality of additional symbols displayed on the display means is displayed on the blank symbol, thus the player can be given a sense of expectancy by the number of additional symbols to be displayed on the display means.

In the gaming machine according to the first aspect, the control means preferably changes at least one of the identity of the additional symbol and the number of additional symbols. In this case, for example, the identity of the additional symbol and/or the number of additional symbols can be changed for each game, thus the player can be given a different type of sense of expectancy for each game.

In the gaming machine according to the first aspect, the control means preferably determines at least one of the identity of the additional symbols and the number of additional symbols before variable display is started by the variable display section, and cause the display means to display the additional symbols. In this case, the player can recognize the additional symbols to be displayed on the blank symbols prior to the start of variable display, thus the player can be given a sense of expectancy from the initial stage of the game.

In the gaming machine according to the first aspect, the additional symbols may be symbols included in the plurality of symbols displayed on the variable display section, or may be symbols for providing a predetermined award to the player when being added and displayed on the blank symbols. In the former case, the player can be allowed to expect that a winning combination, which partially has the additional symbol displayed on the blank symbol, is established. In the latter case, the player can be allowed to expect a predetermined award from the additional symbol displayed.

Moreover, the gaming machine according to the first aspect has the following characteristics.

Specifically, it is preferred that the variable display section comprises a transparent liquid crystal display.

Furthermore, it is preferred that determination of at least one of the identity of the additional symbol and the number of additional symbols be performed through random number lottery processing.

Additionally, it is preferred that the symbol for providing the predetermined award be a symbol for paying out a predetermined number of coins.

Moreover, in order to achieve the above-described objects, a second aspect of the present invention comprises: first variable display means for variably displaying a plurality of symbols used in a first game; second variable display means for variably displaying a plurality of symbols used in a second game which is played in addition to the first game; display means disposed opposite the both variable display means and for displaying at least one effect corresponding to a state of a game; and control means for controlling the variable display performed by the both variable display means and the at least one effect displayed by the display means; wherein when the second variable display means displays a blank symbol included in the plurality of symbols, the control means causes the display means to display any symbol included in the plurality of symbols, on a position which corresponds to the blank symbol in the display means.

According to the gaming machine related to the second aspect, when displaying blank symbols contained in the plurality of symbols by the second variable display means used in the second game, the control means causes the display means to display any symbol contained in the plurality of symbols, on a position which corresponds to the blank symbol in the display means, whereby the player can be allowed to expect a profit from display of other symbol on the blank symbol, thus the gaming interest in the second game (sub-game) can be increased.

In the gaming machine according to the second aspect, the second variable display means is preferably disposed at an end portion of a display region in the display means. In this case, a display region in the display means where the second variable display means is not disposed can be used for displaying the effects, thus the gaming interest in playing the second game (sub-game) can be increased through this display of the effects.

In the gaming machine according to the second aspect, a size of the second variable display means is preferably smaller than that of the first variable display means. In this case, under a circumstance where the display region facing the player is limited, a space inside the cabinet of the gaming machine can be efficiently utilized.

It should be noted that in this case as well, the gaming machine according to the second aspect displays other symbol on a position which corresponds to the blank symbol in the second variable display means, thus the gaming interest in the second game (sub-game) can be increased while preventing a negative effect of reducing the size of the second variable display means.

In the gaming machine according to the second aspect, the control means may cause the display means to display an additional symbol which is displayed on a position which corresponds to the blank symbol in the second variable display means. In this case, the player can be allowed to predict a profit in a case where the additional symbol is displayed on a position corresponding to the blank symbol, thus the gaming interest in playing the game can be further increased.

Further, the gaming machine according to the second aspect has the following characteristics.

Specifically, the first variable display means and the second variable display means are preferably reels in which a plurality of symbols are formed on circumferential surfaces thereof.

Moreover, the display means for displaying the effects preferably is a liquid crystal display.

Furthermore, preferably the first game is a basic game, and the second game is a bonus game.

Further, in the first game, preferably the display means for displaying the at least one effect is brought into a state so that the symbols displayed variably on the first variable display means are viewed, and a state so that symbols displayed variably on the second variable display means are not viewed.

Additionally, in the second game, preferably the display means for displaying the at least one effect is brought into a state so that the symbols displayed variably on the first variable display means are not viewed, and a state so that the symbols displayed variably on the second variable display means are viewed.

Further, the gaming machine according to the present invention comprises: a slot game; a plurality of reels for executing the slot game, where each reel has a plurality of symbols; a group of additional symbols to be utilized in the slot game; and a processor programmed to operate with the plurality of reels and the group of additional symbols to (a) enable a player to initiate the slot game by making a bet, (b) determine the group of additional symbols, (c) display the group of additional symbols while the plurality of reels are spinning, (d) superimpose a symbol of the group of additional symbols onto a blank symbol, if the blank symbol included in the plurality of symbols stops and displays with a predetermined combination of the plurality of symbols.

Moreover, the gaming machine according to the present invention comprises: a basic game; a first plurality of reels for executing the basic game, where each reel has a first plurality of symbols; a bonus game; a second plurality of reels for executing the bonus game, where each reel has a second plurality of symbols; a group of additional symbols to be utilized in the bonus game; and a processor programmed to operate with the first and second plurality of reels and the group of additional symbols to (a) enable a player to initiate the basic game by making a bet, (b) shift from the basic game to the bonus game, (c) determine the group of additional symbols, (d) display the group of additional symbols while the second plurality of reels are spinning, (e) superimpose a symbol of the group of additional symbols onto a blank symbol, if the blank symbol included in the second plurality of symbols stops and displays with a predetermined combination of the second plurality of symbols.

### BRIEF DESCRIPTION OF THE DRAWINGS

FIG. 1A is a perspective view showing an external configuration of a slot machine which is a gaming machine according to a first embodiment of the present invention;

FIG. 1B is a perspective view showing an external configuration of a slot machine which is a gaming machine according to a second embodiment of the present invention;

FIG. 2 is a figure showing examples of symbol columns displayed variably on a variable display section of the slot machine;

FIG. 3A is a block diagram schematically showing a control system of the slot machine related to the first embodiment;

FIG. 3B is a block diagram schematically showing a control system of the slot machine related to the second embodiment;

FIG. 4 is a block diagram schematically showing a liquid crystal drive circuit of the slot machine related to the first embodiment;

FIG. 5 is a flowchart of an example of main processing in the slot machine related to the first embodiment;

FIG. 6 is a flowchart of an example of start reception processing in the slot machine related to the first embodiment;

FIG. 7A is a flowchart of an example of lottery processing in the slot machine related to the first embodiment;

FIG. 7B is a flowchart of an example of lottery processing in the slot machine related to the second embodiment;

FIG. 8 is a flowchart of an example of additional symbol lottery processing which is executed in the lottery processing;

FIG. 9 is a figure showing an example of an additional symbol table which is used in additional symbol determination processing executed in the additional symbol lottery processing;

FIG. 10 is a figure showing an example of a symbol candidate table which is used in symbol candidate determination processing executed in the additional symbol lottery processing;

FIG. 11 is a flowchart showing an example of basic game processing in the slot machines related to the first and second embodiments;

FIG. 12 is a flowchart showing an example of bonus game processing in the slot machines related to the first and second embodiments;

FIG. 13 is a flowchart showing an example of free spin processing in the slot machines related to the first and second embodiments;

FIG. 14 shows an example of a display screen of a lower liquid crystal display when a game of the slot machine related to the first embodiment is being executed;

FIG. 15 shows an example of the display screen of the lower liquid crystal display when a game of the slot machine related to the first embodiment is being executed;

FIG. 16 shows an example of the display screen of the lower liquid crystal display when a game of the slot machine related to the first embodiment is being executed;

FIG. 17 shows an example of the display screen of the lower liquid crystal display in a case where award symbols as additional symbols are displayed on blank symbols, in the slot machine related to the first embodiment;

FIG. 18 is a flowchart showing an example of the lottery processing in the free spin processing shown in FIG. 13;

FIG. 19 shows an example of the display screen of the lower liquid crystal display in each gaming state (initial state) of the slot machine related to the second embodiment;

FIG. 20 shows an example of the display screen of the lower liquid crystal display when the basic game processing is being executed, in the slot machine related to the second embodiment;

FIG. 21 shows an example of the display screen of the lower liquid crystal display when the bonus game processing is being executed, in the slot machine related to the second embodiment;

FIG. 22 shows an example of the display screen of the lower liquid crystal display in which additional symbols are displayed on blank symbols, in the slot machine related to the second embodiment; and

FIG. 23 shows an example of the display screen of the lower liquid crystal display in which are displayed symbol candidates which can be displayed on the blank symbols, in the slot machine related to the second embodiment.

### DESCRIPTION OF THE PREFERRED EMBODIMENTS

The first embodiment and the second embodiment are described in succession hereinafter. Descriptions of the sections in the second embodiment which overlap with those in the first embodiment are omitted.

### First Embodiment

Hereinafter, with regard to the gaming machine of the present invention, the present invention is described in detail with reference to the drawings on the basis of the embodiments in which the slot machine is embodied.

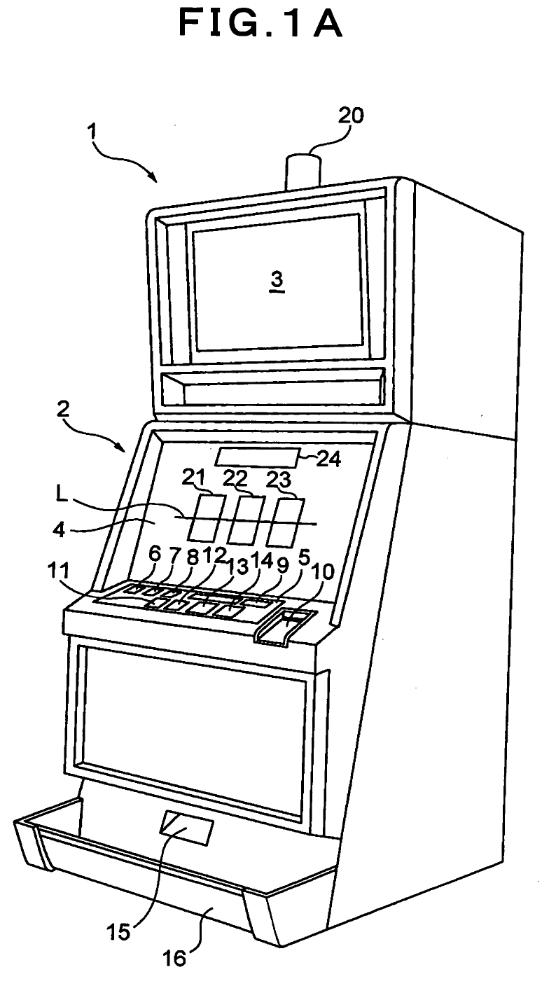

FIG. 1 is a perspective view showing an external configuration of a slot machine related to a first embodiment. In FIG. 1, the slot machine 1 has a cabinet 2 which forms the whole of the slot machine, wherein a lamp 20 is disposed on an upper part on the top surface of the cabinet 2. Further, an upper liquid crystal display 3 is disposed on an upper part of the front surface of the cabinet 2, and a lower liquid crystal display 4 which functions as display means is disposed on a central part of the front surface of the cabinet 2.

The upper liquid crystal display 3 is configured from a liquid crystal display which is used in general, and displays information on a game, such as a game method, a type of a winning combination and its award, and various effects related to the game. The lower liquid crystal display 4 is configured from a so-called transparent liquid crystal display, and displays three variable display sections 21, 22, and 23, as shown in FIG. 1A. Furthermore, when symbols, “blank” (referred to as “blank symbol” accordingly hereinafter), which are described hereinbelow, are displayed in the variable display sections 21 through 23, an additional symbol display section 24 displaying an additional symbol which can be displayed in addition to the blank symbol is displayed.

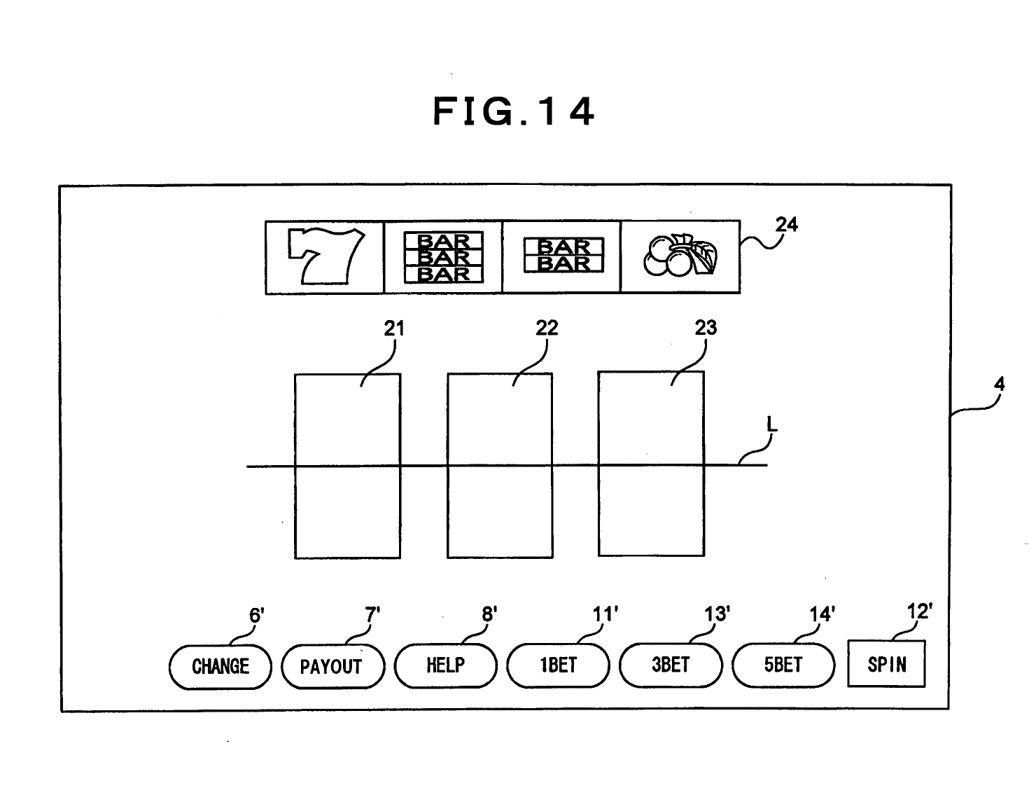

In the present embodiment, one active pay line L is provided on these three variable display sections 21 through 23. In each of the variable display sections 21 through 23, various symbols described hereinafter are displayed while scrolling from top to bottom. Furthermore, on the lower liquid crystal display 4, there are displayed operation keys (touch keys) corresponding to various buttons (a CHANGE button 6, a PAYOUT button 7, and other buttons for accepting an operation instruction, which are required when a player plays a game) provided on a control panel 5 which is described hereinafter (see FIG. 14). Moreover, as in the upper liquid crystal display 3, various effects and the like related to the game are displayed.

The control panel 5 protruding forward is provided on a lower side of the lower liquid crystal display 4. The control panel 5 is provided with, from the leftmost side, the CHANGE button 6, the PAYOUT button 7, and a HELP button 8, and a coin insertion slot 9 and a bill insertion slot 10 are provided on the right side of the HELP button 8. A 1-BET button 11, a SPIN (SPIN/REPEAT BET) button 12, a 3-BET button 13, and a 5-BET button 14 are disposed from the left side on the front side of the control panel 5.

The CHANGE button 6 is a button for illuminating the lamp 20. The PAYOUT button 7 is a button which is pressed when the basic game is ended. When the PAYOUT button 7 is pressed, coins as gaming media which are acquired during a game are paid out from a coin payout opening 15 to a coin tray 16. The HELP button 8 is a button which is pressed when an operation method or the like of a game is unclear. When the HELP button 8 is pressed, various help information is displayed on the upper liquid crystal display 3 or lower liquid crystal display 4.

A coin sensor 65 which detects an inserted coin is disposed on the coin insertion slot 9. A bill sensor 66 which detects an inserted bill is disposed in the bill insertion slot 10. A single bet is placed every time the 1-BET button 11 is pressed. The SPIN button 12 is a button for starting variable display of various symbols on the variable display sections 21 through 23 of the lower liquid crystal display 4, in order to start a game at the current number of bets or the previous number of bets based on that the button is pressed. 1, 2, 3, 4, or 5 bets may be present as the number of bets that can be placed upon pressing of the SPIN button 12.

The 3-BET button 13 is a button for starting a game with three bets. The 5-BET button 14 is a button for starting a game with five bets. The coin payout opening 15 is formed in a lower portion of the cabinet 2, and the coin tray 16 is provided for receiving a coin paid out from the coin payout opening 15.

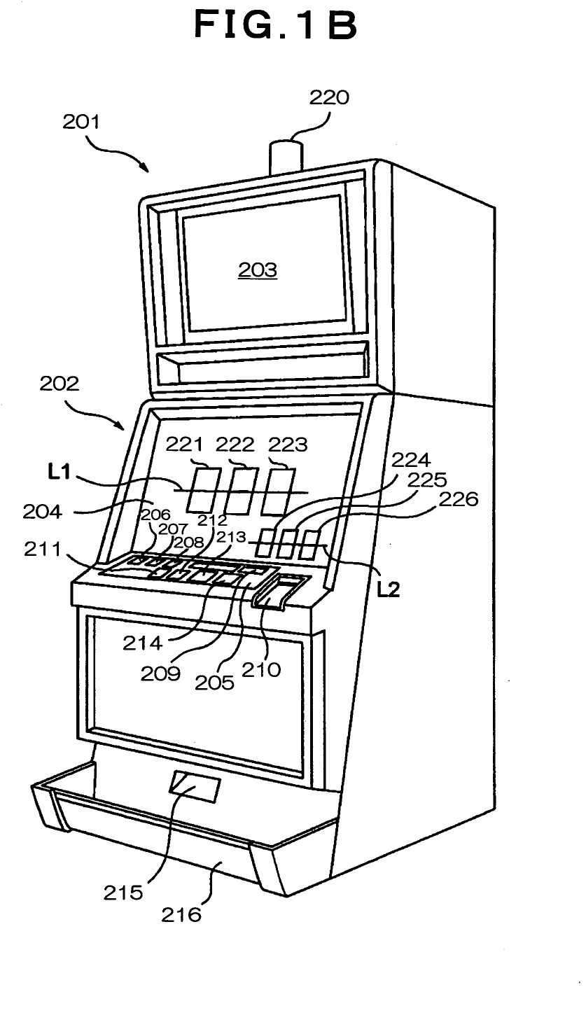

Here, FIG. 2 is used to describe examples of symbols which are variably displayed while scrolling on the variable display sections 21 through 23 of the lower liquid crystal display 4. FIG. 2 is a figure showing examples of symbol columns which are displayed variably while scrolling on the variable display sections 21 through 23 of the lower liquid crystal display 4. In FIG. 2, a symbol column 141 is a symbol column displayed variably on the variable display section 21, a symbol column 142 is a symbol column displayed variably on the variably display section 22, and a symbol column 143 is a symbol column displayed variably on the variable display section 23.

The symbol columns 141 and 142 have an identical symbol arrangement, and each of these symbol columns is constituted by eleven symbols comprising appropriate combinations of a triple BAR 91, a cherry 92, a double BAR 93, a seven 94, a single BAR 95, and a blank (a region in which no symbol exists) 96.

The symbol column 143 is different from the symbol columns 141 and 142 in that, in addition to the symbols included in the symbol columns 141 and 142, a single trigger symbol 97 is arranged. The trigger symbol 97 is a symbol for advancing to a bonus game which is described hereinafter, and thus when the trigger symbol 97 is stopped and displayed on the active pay line L in the variable display section 23, the gaming state advances to the bonus game.

It should be noted that when each of the scrolling symbol columns 141 through 143 is stopped and displayed in each of the variable display sections 21 through 23, three symbols are stopped and displayed on the active pay line L. Moreover, various winning combinations are set beforehand on the basis of a plurality of symbol combinations, and when a symbol combination corresponding to a winning combination stops on the active pay line L, coins are paid out from the coin payout opening 15 in accordance with the winning combination. This point is similar to a conventional slot machine, and thus further description is omitted here.

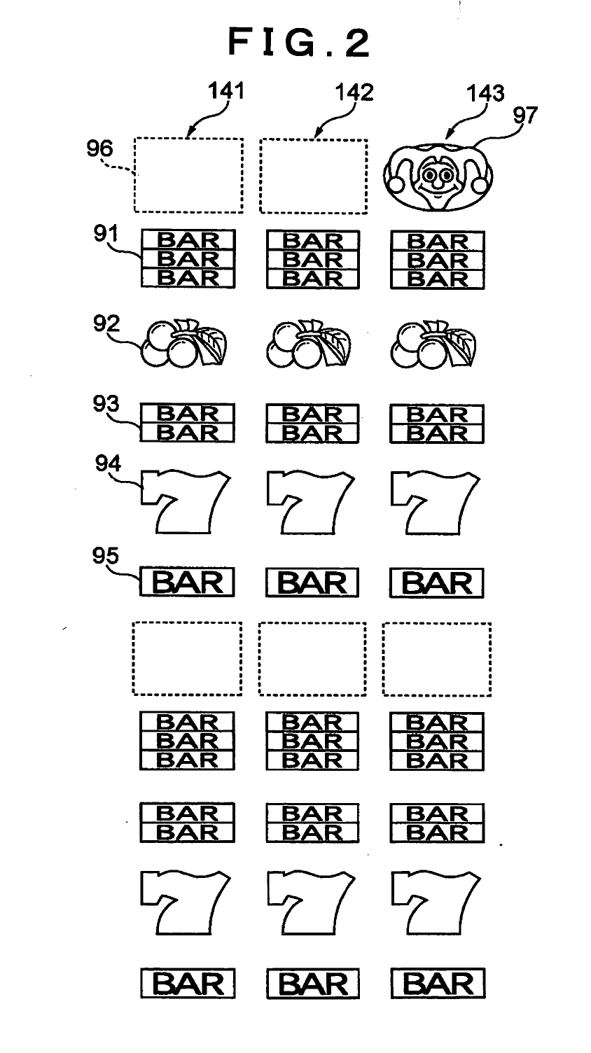

Next, the configuration of the control system of the slot machine 1 is described on the basis of FIG. 3A. FIG. 3A is a block diagram schematically showing the control system of the slot machine.

In FIG. 3A, the control system of the slot machine 1 is basically constituted by, as a core, a microcomputer 100 comprising a CPU 50 functioning as control means, a ROM 51 and a RAM 52, and the ROM 51 and the RAM 52 are connected to the CPU 50. The ROM 51 stores various programs and data tables used for performing various processing, such as main processing, start reception processing, lottery processing, basic game processing, bonus game processing, and the like which are required to control the slot machine 1. The RAM 52 is a memory for temporarily storing various data computed by the CPU 50.

It should be noted in the present embodiment that the programs and data used when controlling the slot machine 1 are not only stored in the ROM 51 and RAM 52, but also changed appropriately. For example, similar programs or data may be stored in a recording medium such as a Compact Flash (U.S. Trademark Registration No. 2,515,962) and downloaded to the ROM 51 or the like from such a recording medium.

A clock pulse generating circuit 53 for generating a reference clock pulse, a divider 54, a random number generator 55 for generating random numbers, and a random number sampling circuit 56 are connected to the CPU 50. Random numbers sampled by the random number sampling circuit 56 are used in various lotteries of winning combinations and the like. Further, a SPIN switch 58 annexed to the SPIN button 12, a 1-BET switch 59 annexed to the 1-BET button 11, a 3-BET switch 60 annexed to the 3-BET button 13, a 5-BET switch 61 annexed to the 5-BET button 14, a CHANGE switch 62 annexed to the CHANGE button 6, a PAYOUT switch 63 annexed to the PAYOUT button 7, and a HELP switch 64 annexed to the HELP button 8 are connected to the CPU 50. The CPU 50 performs control to execute various operations corresponding to each button on the basis of a switch signal which is output from each of switch when each button is pressed.

The coin sensor 65 disposed in the coin insertion slot 9 and the bill sensor 66 disposed in the bill insertion slot 10 are connected respectively to the CPU 50. The coin sensor 65 detects a coin inserted through the coin insertion slot 9, and the CPU 50 computes the number of inserted coins on the basis of a coin detection signal output from the coin sensor 65. The bill sensor 66 detects the type and value of a bill inserted through the bill insertion slot 10, and the CPU 50 computes the number of coins equivalent to the value of the bill on the basis of a bill detection signal output from the bill sensor 66.

A hopper 71 is connected to the CPU 50 via a hopper drive circuit 70. When a drive signal is output to the hopper drive circuit 70 from the CPU 50, the hopper 71 pays out a predetermined number of coins from the coin payout opening 15. Furthermore, a coin detection unit 73 is connected to the CPU 50 via a payout completion signal circuit 72. The coin detection unit 73 is disposed inside the coin payout opening 15. When it is detected that a predetermined number of coins are paid out from the coin payout opening 15, a coin payout detection signal is output to the payout completion signal circuit 72 from the coin detection unit 73. On the basis of this coin payout detection signal, the payout completion signal circuit 72 outputs a payout completion signal to the CPU 50.

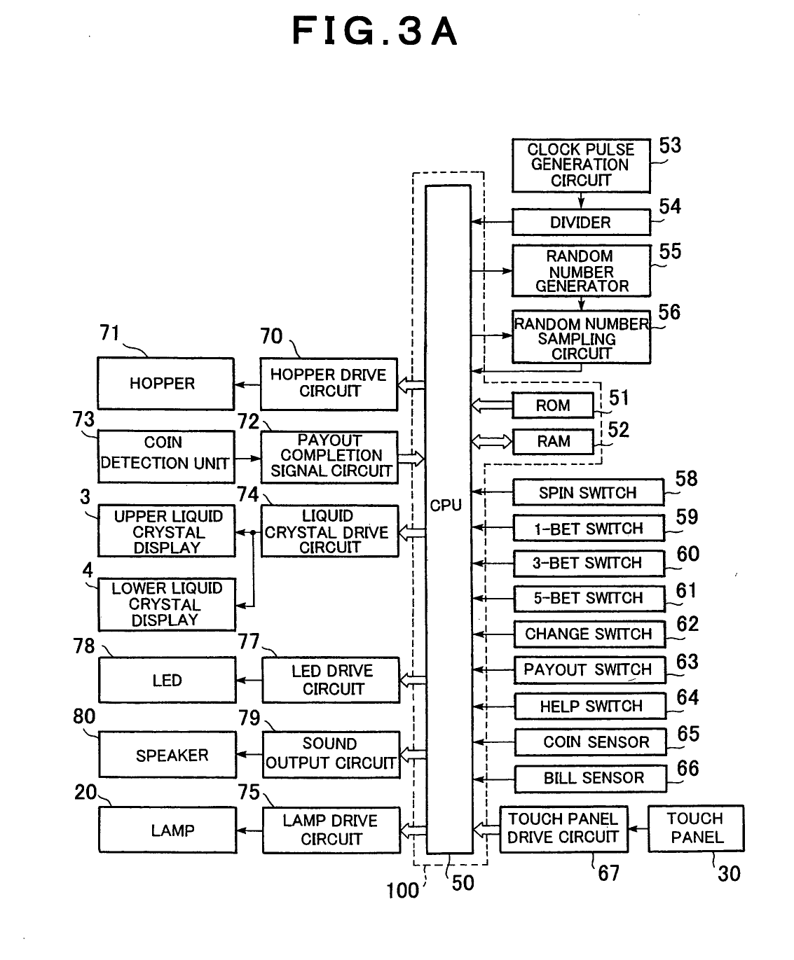

The upper liquid crystal display 3 and lower liquid crystal display 4 are connected to the CPU 50 via a liquid crystal drive circuit 74, thus the upper liquid crystal display 3 and lower liquid crystal display 4 can be controlled by the CPU 50. As shown in FIG. 4, the liquid crystal drive circuit 74 is constituted by a program ROM 81, an image ROM 82, an image control CPU 83, a work RAM 84, a VDP (video display processor) 85, a video RAM 86, and the like.

In FIG. 4, the program ROM 81 stores an image control program and various selection tables related to the display on the lower liquid crystal display 4. The image ROM 82 stores dot data and the like for forming images, such as the symbol columns 141 through 143 of FIG. 2 displayed on the variable display sections 21 through 23 of the lower liquid crystal display 4, and additional symbols displayed on the additional symbol display section 24. The image control CPU 83 determines an image to be displayed on the lower liquid crystal display 4 from among the dot data stored beforehand in the image ROM 82 on the basis of parameters set by the CPU 50 and in accordance with an image control program stored beforehand in the program ROM 81. The work RAM 84 is configured as temporary storage means when the image control program is executed by the image control CPU 83. The VDP 85 creates image data corresponding to the display content determined by the image control CPU 83, and outputs the image data to the lower liquid crystal display 4. It should be noted that the video RAM 86 is configured as temporary storage means when an image is formed by the VDP 85.

Returning to FIG. 3A, more explanation of the control system of the slot machine is continued. An LED 78 is connected to the CPU 50 via an LED drive circuit 77. A large number of the LEDs 78 is provided on the front surface of the slot machine 1, and when various effects are to be performed, the LEDs 78 are controlled to be illuminated by the LED drive circuit 77 on the basis of a drive signal from the CPU 50. A sound output circuit 79 and a speaker 80 are connected to the CPU 50. The speaker 80 generates various sound effects when various effects are performed on the basis of an output signal sent from the sound output circuit 79.

The lamp 20 is connected to the CPU 50 via a lamp drive circuit 75. The lamp 20 is disposed on the upper surface of the slot machine 1 (see FIG. 1), and, when the CHANGE button 6 is pressed, controlled to be illuminated by the lamp drive circuit 75 on the basis of a drive signal from the CPU 50.

A transparent touch panel 30 is connected to the CPU 50 via a touch panel drive circuit 67. The transparent touch panel 30 is mounted on the screen of the lower liquid crystal display 4, and outputs coordinate position information of a section touched by the player, via the touch panel drive circuit 67, so that the CPU 50 can determine which part is touched.

Next, an operation example of the slot machine 1 having the above configurations is described.

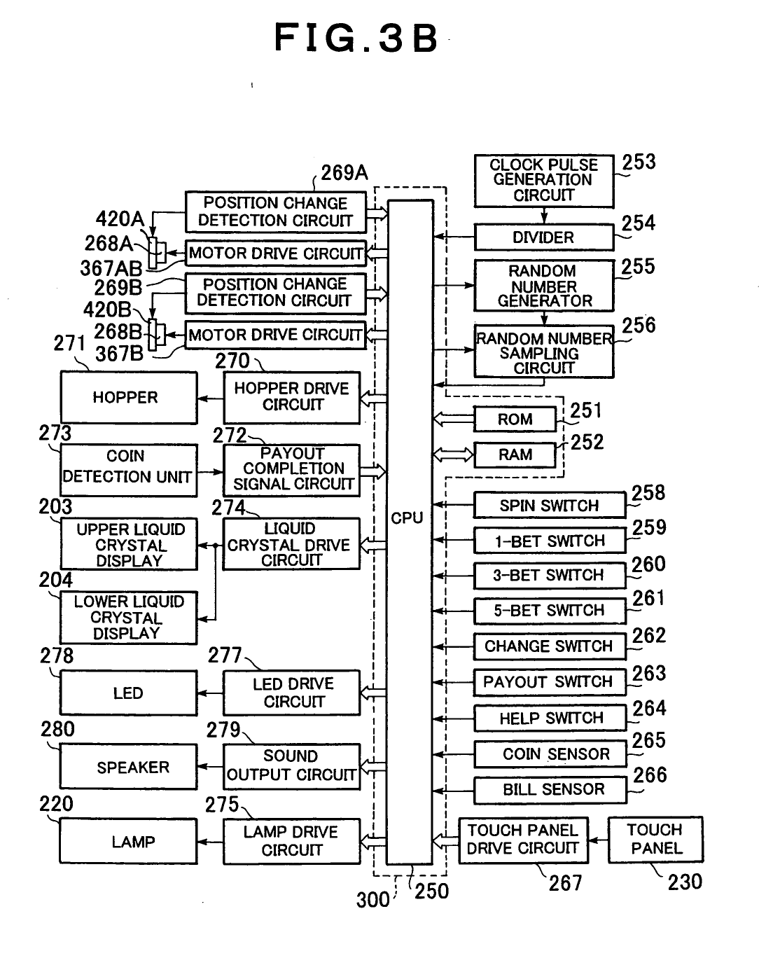

First, an example of the main processing performed in the slot machine 1 is described on the basis of FIG. 5. FIG. 5 is a flowchart showing an example of the main processing. When starting the main processing, the slot machine 1 (more specifically, the CPU 50) executes the start reception processing (step (abbreviated to “S” hereinafter) 11). In this processing, a switch signal, which is output from the SPIN switch 58, 1-BET switch 59, 3-BET switch 60, or 5-BET switch 61 on the basis of an operation of the SPIN button 12, an operation of the 1-BET button 11, an operation of the 3-BET button 13, or an operation of the 5-BET button 14, is received. A game is started at the point of time when the switch signal output from each of the switches is received.

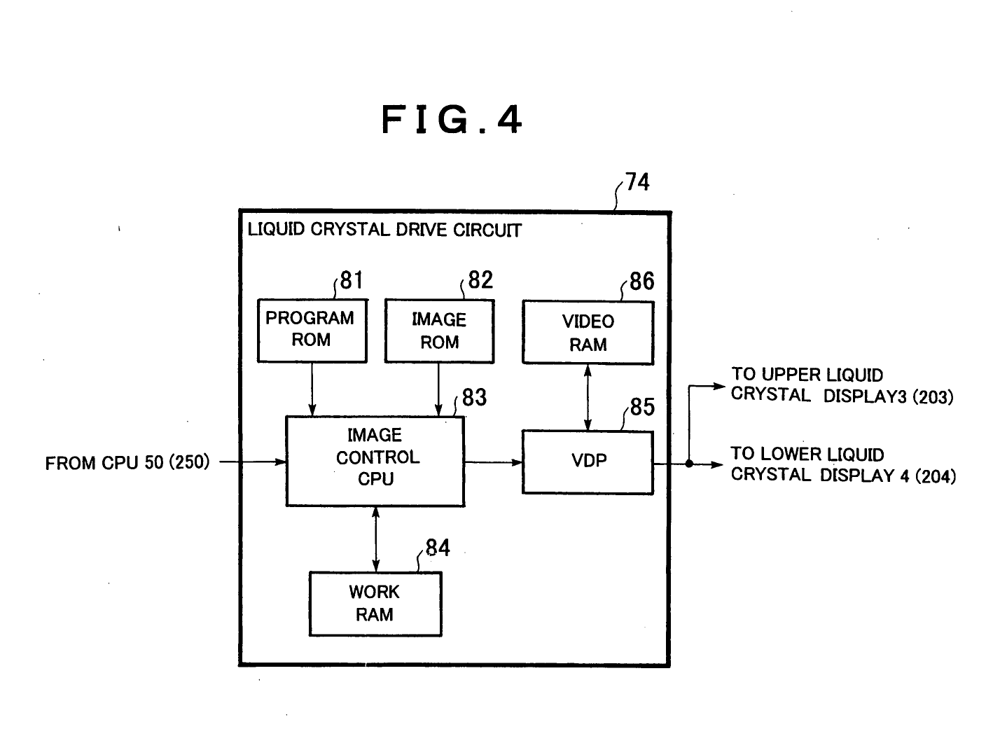

The start reception processing performed in the slot machine 1 is described on the basis of FIG. 6. FIG. 6 is a flowchart showing an example of the start reception processing. In S11 of the main processing shown in FIG. 5, the CPU 50 first determines whether or not a predetermined time period (15 seconds, for example) has elapsed (S21). Here, if it is determined that the predetermined time period has not elapsed (S21: No), the step proceeds to S23 without performing any operations. If it is determined that the predetermined time period has elapsed (S21: YES), demo effect processing is performed in the upper liquid crystal display 3 and lower liquid crystal display 4 in S22, and thereafter the step proceeds to S23. It should be noted that the demo effect processing is carried out in accordance with an effect pattern which is set beforehand.

In S23, the CPU 50 determines whether or not the SPIN button 12, the 1-BET button 11, the 3-BET button 13, or the 5-BET button 14 is operated. Here, if it is determined that the 1-BET button 11 or the like is not operated (S23: NO), the step returns to S21, where the processing described above is repeated. If, on the other hand, it is determined that the 1-BET button 11 or the like is operated (S23: YES), the step returns to the main processing program of FIG. 5 even if the demo effect processing is performed, and proceeds to the lottery processing of S12.

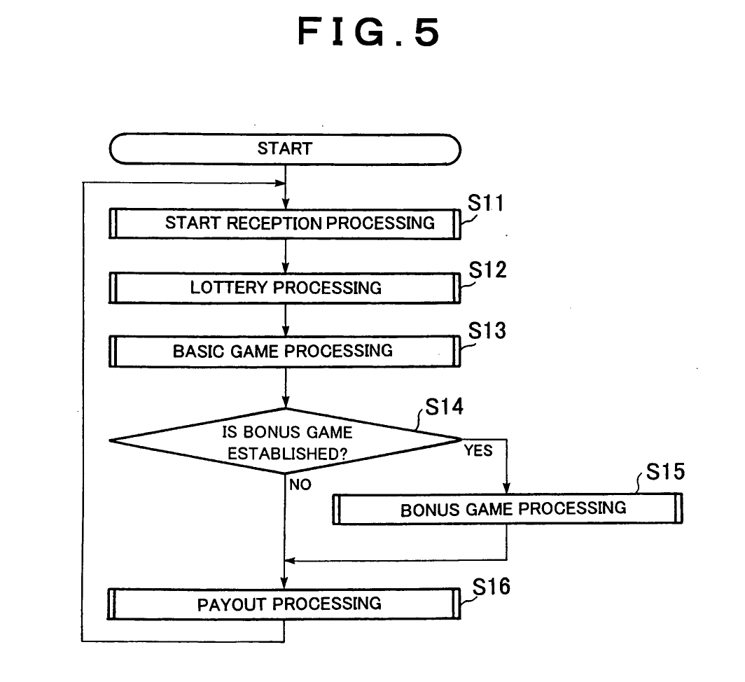

Next, the lottery processing (S12) performed in the slot machine 1 is described on the basis of FIG. 7A. FIG. 7A is a flowchart showing an example of the lottery processing. In S12 of the main processing shown in FIG. 5, the CPU 50 first performs the additional symbol lottery processing (S31). In this additional symbol lottery processing, when blank symbols are displayed on the variable display sections 21 through 23, additional symbols to be additionally displayed on the blank symbols are determined, and candidates of additional symbols (“symbol candidate” hereinafter) to be displayed on the additional symbol display section 24 are determined.

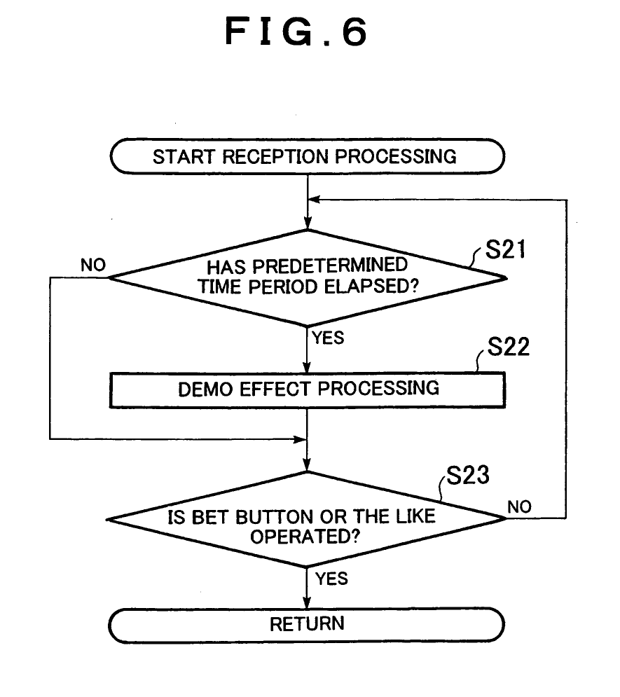

Here, the additional symbol lottery processing executed in the lottery processing is described on the basis of FIG. 8. As shown in FIG. 8, when the additional symbol lottery processing is started, the CPU 50 first performs random number extraction processing (for symbol determination) (S41). In this random number extraction processing, the CPU 50 samples random numbers by means of the random number sampling circuit 56. At this moment, the CPU 50 extracts two random numbers used in additional symbol determination processing (S42) and symbol candidate determination processing (S43) described hereinafter.

After the random numbers are extracted in the random number extraction processing (S41), the CPU 50 executes the subsequent additional symbol determination processing (S42). In this additional symbol determination processing, when blank symbols are displayed in the variable display sections 21 through 23, additional symbols to be displayed additionally on the blank symbols are determined. In this additional symbol determination processing, the random numbers extracted in S41 are compared with an additional symbol table in which is described the relationship between a random number and an additional symbol which are prepared beforehand, to determine additional symbols corresponding to the extracted random numbers.

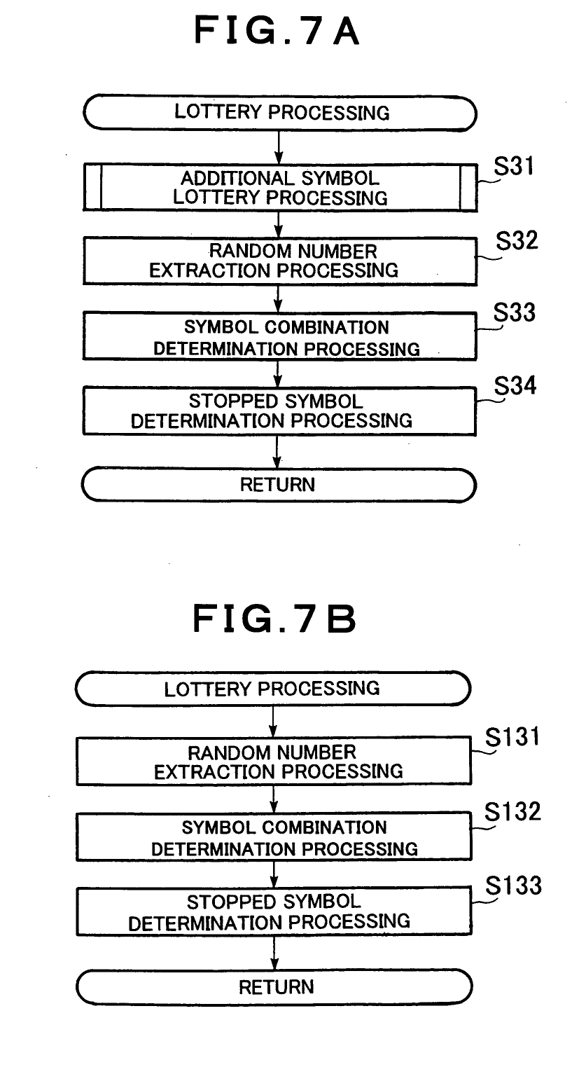

FIG. 9 is a figure showing an example of the additional symbol table which is used in the additional symbol determination processing. As shown in FIG. 9, in the additional symbol table, there are described an additional symbol of “seven” if the random number value is within a range of 1 through 5, an additional symbol of “triple BAR” if the random number value is within a range of 6 through 15, an additional symbol of “double BAR” if the random number value is within a range of 16 through 35, an additional symbol of “single BAR” if the random number value is within a range of 36 through 75, and an additional symbol of “cherry” if the random number value is within a range of 76 through 155.

After the additional symbols are determined in the additional symbol determination processing (S42), the CPU 50 executes subsequently the symbol candidate determination processing (S43). In this symbol candidate determination processing, a symbol candidate to be displayed on the additional symbol display section 24 is determined. In this symbol candidate determination processing, the random numbers extracted in S41 are compared with a symbol candidate table in which is described the relationship between a random number and a symbol candidate which are prepared beforehand, to determine symbol candidates corresponding to the extracted random numbers.

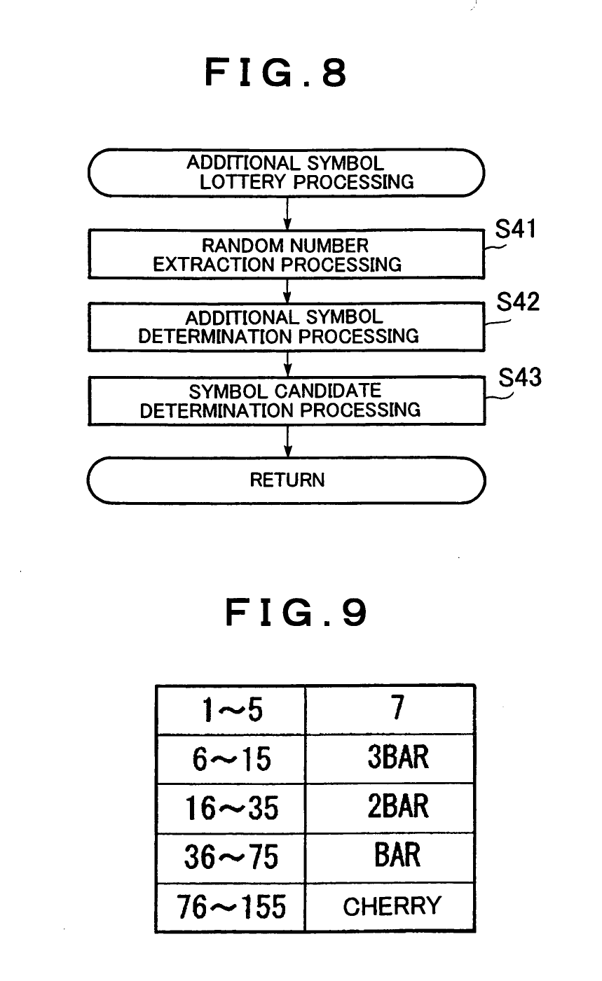

FIG. 10 is a figure showing an example of the symbol candidate table which is used in the symbol candidate determination processing. FIG. 10 shows an example of a symbol candidate which can be selected when a symbol of “seven” is determined as an additional symbol. If the symbol of “seven” is determined as an additional symbol, at least one symbol of “seven” is included in the symbol candidates. Hereinafter, there is described a case in which four symbol candidates are displayed in the additional symbol display section 24.

As shown in FIG. 10, the symbol candidate table describes, for example, that if the random number value is 1 four symbols of “seven” are displayed as the symbol candidates, if the random number value is within a range of 2 through 15 one through three symbols of “triple BAR” are displayed in addition to the symbols of “seven”, if the random number value is within a range of 16 through 29 one through three symbols of “double BAR” are displayed in addition to the symbols of “seven”, if the random number value is within a range of 30 through 43 one through three symbols of “single BAR” are displayed in addition to the symbols of “seven”, and if the random number value is within a range of 44 through 57 one through three symbols of “cherry” are displayed in addition to the symbols of “seven”.

It should be noted here that a case in which one type of symbol different from the symbol of “seven” is displayed, but there are two or more types of symbols are mixed and displayed as the actual symbol candidates. Furthermore, FIG. 10 shows a case in which the symbol of “seven” is determined as the additional symbol, but the symbol candidate table describes a case in which the symbols of “triple BAR”, “double BAR”, “single BAR”, and “cherry” are determined as the additional symbols.

After the symbol candidates are determined in the symbol candidate determination processing (S43), the CPU 50 returns to the lottery processing shown in FIG. 7A and proceeds to the random number extraction processing (for determining a symbol combination) of S32. In this random number extraction processing, the CPU 50 samples one random number by means of the random number sampling circuit 56.

After a random number is extracted in the random number extraction processing (S32), the CPU 50 executes symbol combination determination processing (S33). In this symbol combination determination processing, the random number extracted in S32 is compared with a lottery table in which is described the relationship between a random number and a symbol combination (including the losing combination) which are prepared beforehand, to determine a symbol combination corresponding to the extracted random number. This lottery table describes, for example, that the symbol combination is “bonus game” if the random number value is within a range of 1 through 10, “all seven” if the random number value is within a range of 11 through 40, and “lost” if the random number value is within a range of 341 through 1024. It should be noted that the above symbol combination, “all seven”, is obtained when the symbols stopped on the active pay line L are all “seven”.

Subsequent to the symbol combination determination processing (S33), the CPU 50 executes stopped symbol determination processing (S34). In this stopped symbol determination processing, a symbol stopped and displayed on the active pay line L is determined for each of the variable display sections 21 through 23 so that the symbol combination determined in the symbol combination determination processing is established. Specifically, the CPU 50 determines a code number of the stopped symbol so that a combination of symbols corresponding to the determined symbol combination is established on the active pay line L.

It should be noted that when the stopped symbol determination processing is performed, the CPU 50 considers not only the original symbols but also the additional symbols to be displayed on the blank symbols. For example, in the case where the symbol of “seven” is determined as the additional symbol in the additional symbol determination processing (S42) shown in FIG. 8, and the symbol combination of “all seven” is determined in the symbol combination determination processing (S33) shown in FIG. 7A, the stopped symbol determination processing may be performed so that a combination of the symbol “seven” and the blank symbol is stopped and displayed on the active pay line L. Then, after the stopped symbol determination processing (S34) is finished, the step returns to the main processing shown in FIG. 5 and then proceeds to basic game processing of S13.

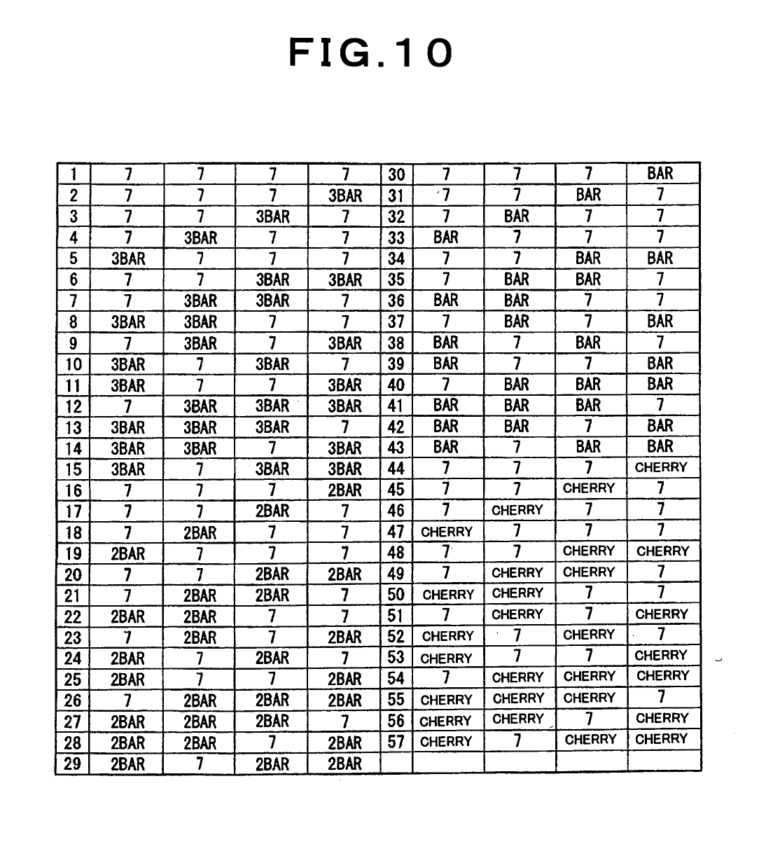

Next, the basic game processing (S13) performed in the slot machine 1 of the present embodiment is described on the basis of FIG. 11. FIG. 11 is a flowchart showing an example of the basic game processing. In S13 of the main processing shown in FIG. 5, the CPU 50 first executes rotation processing (S51) to start scrolling each symbol on each of the three variable display sections 21 through 23 on the basis of the switch signal which is output from the SPIN switch 58, 1-BET switch 59, 3-BET switch 60, or 5-BET switch 61 and received in the start reception processing (S11).

Next, the CPU 50 executes stop control processing (S52) to stop the scrolling of the three variable display sections 21 through 23 in order to stop the stopped symbol determined in the lottery processing (S12) on the active pay line L, more specifically in the stopped symbol determination processing (S34). It should be noted here that when a blank symbol is stopped and displayed on the active pay line L, the additional symbol (the image of the additional symbol) determined in the previous additional symbol determination processing (S42) is displayed on the blank symbol.

Next, the CPU 50 executes addition computation processing (S53) for temporarily adding the value of coins equivalent to the award which is set beforehand to the coins to be paid out, in accordance with the combination of symbols stopped and displayed on the variable display sections 21 through 23 in the stop control processing (S52). It should be noted that these coins to be paid out are allocated and stored in a fixed region in the RAM 52. In this addition computation processing, coins and the like are added in accordance with the symbol combination determined in the abovementioned symbol combination determination processing (S33). It should be noted that after the addition computation processing is executed, the CPU 50 returns to the main processing shown in FIG. 5.

Returning to FIG. 5, more explanation of the main processing is continued. After the basic game processing (S13) is executed, the CPU 50 determines whether or not the bonus game is established (S14). This determination is made on the basis of the symbols stopped on the active pay line L in the stop control processing (S52) in the basic game processing shown in FIG. 11, or on the basis of the random number or symbol combination determined in the lottery processing (S12).

When it is determined that the bonus game is established (S14: Yes), the CPU 50 executes the bonus game processing (S15). In the bonus game processing (S15), the slot machine 1 executes a free game in which the predetermined number (10 in the present embodiment) of free spins are performed. Specifically, in the slot machine 1 of the present embodiment, the bonus game is same as the free game in which 10 free spins are allowed to be performed.

When performing free spins, processing similar to the basic game processing is performed without allowing the player to spend coins or other accumulated credits by inserting coins or pressing any bet buttons. Therefore, during the bonus game, payment with coins or credits can be received without consuming the coins or the number of credits, thus the player can enjoy an advantage that coins or credits can be acquired.

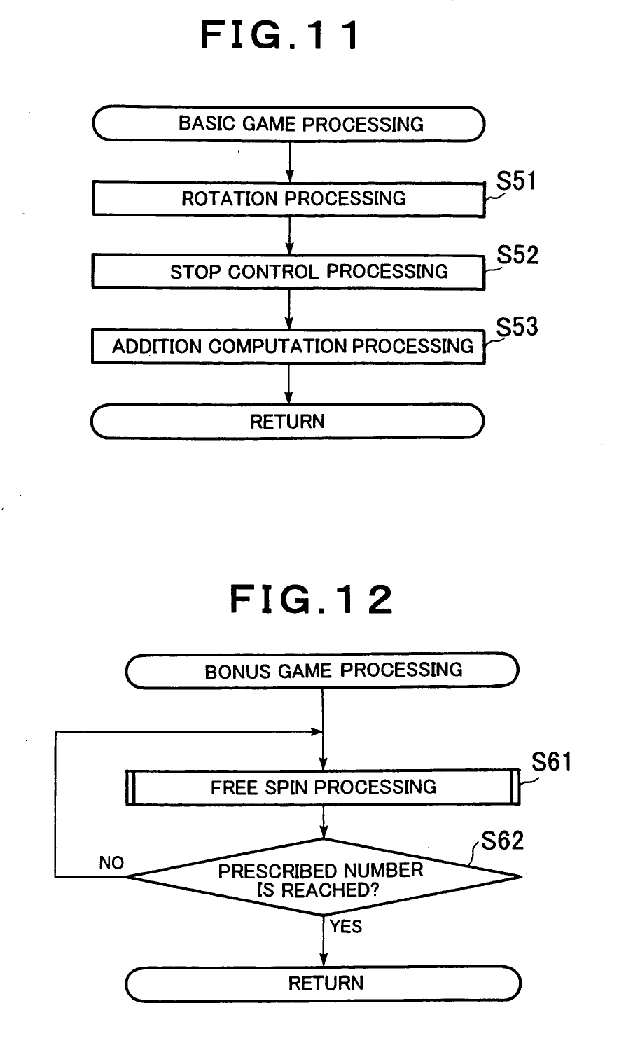

Hereinafter, the bonus game processing performed in the slot machine 1 in the present embodiment is described on the basis of FIG. 12. FIG. 12 is a flowchart showing an example of the bonus game processing. In S15 of the main processing shown in FIG. 5, when the bonus game processing is started, the CPU 50 first executes free spin processing (S61).

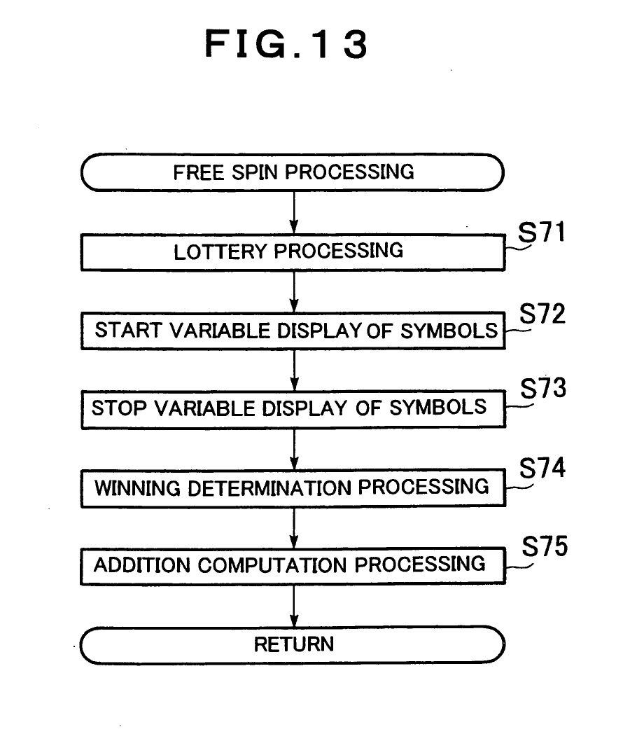

Here, the free spin processing executed in the bonus game processing is described on the basis of FIG. 13. As shown in FIG. 13, when the free spin processing is started, the CPU 50 executes processing similar to the lottery processing (S12) and the basic game processing (S13) shown in FIG. 5 in accordance with a predetermined operation performed by the player, and thus performs lottery processing (S71) (for the bonus game) which is equivalent to the lottery processing (S12). In this lottery processing, the CPU 50 determines symbols to be displayed respectively on the variable display sections 21 through 23 in a state in which variable display is stopped.

Subsequent to the lottery processing (S71), the CPU 50 carries out symbol variable display starting processing (S72) equivalent to the rotation processing (S51) in the basic game processing shown in FIG. 11 and symbol variable display stopping processing (S73) equivalent to the stop control processing (S52). In this symbol variable display stopping processing, the CPU 50 stops variable display of each symbol on each of the variable display sections 21 through 23 so that the symbols determined in the lottery processing (S71) are displayed respectively on the variable display sections 21 through 23.

Next, when the stopped symbols displayed respectively on the variable display sections 21 through 23 include a combination of predetermined symbols, the CPU 50 performs winning determination processing (S74) for calculating the number of coins to be paid out to the player or the number of credits to be newly added to the number of credits having by the player. It should be noted that the timing for performing the winning determination processing can be changed appropriately, and can be performed at any timing after the bonus game processing is started and before the next payout processing (S16) is started.

In the winning determination processing (S74), after the number of coins or the like to be paid out to the player is calculated, the CPU 50 executes addition computation processing for temporarily adding the abovementioned number of coins to the coins to be paid out (S75). When the abovementioned steps S71 through S 75 are carried out, one free spin processing is completed. It should be noted that when the free spin processing is performed, additional symbols on blank symbol may be displayed as in the basic game processing (S13) described above.

Returning to FIG. 12, more explanation of the bonus game processing is continued. When the free spin processing is ended in the manner described above, the CPU 50 determines whether or not the number of executions of the free spin processing, which is a condition for ending the bonus game processing, reaches a prescribed number (10 in the present embodiment) (S62). If the number of executions of the free spin processing does not reach the prescribed number as a result of such determination (S62: No), the CPU 50 executes the free spin processing (S61) again. When, on the other hand, the prescribed number is reached (S62: Yes), the CPU 50 ends the bonus game processing and returns to the main processing.

Returning to FIG. 5, more explanation of the main processing is continued. In S14, if the bonus game is not established (S14: No), and if the bonus game processing (S15) is ended, the CPU 50 carries out payout processing (S16) for discharging, at once, the number of coins equivalent to the number of awards, which are added to the coins to be paid out in the addition computation processing (S53) of the basic game processing or in the addition computation processing (S75) of the free spin processing, or for newly adding the number of awards to the number of credits having by the player. After the payout processing is performed, the CPU 50 returns the processing to the start reception processing (S11) to prepare for the start of the next game. These are the explanations of the main processing and of examples of operations performed in the slot machine.

Hereinafter, an example of a display screen of the lower liquid crystal display 4 when a game of the slot machine 1 related to the first embodiment is being executed is explained. FIG. 14 shows an example of the display screen of the lower liquid crystal display 4 when a game of the slot machine 1 is being executed. The display screen shown in FIG. 14 is displayed on the lower liquid crystal display 4 after the additional symbol lottery processing (FIG. 7A: S31) of the lottery processing (S12) is performed subsequently to the start reception processing (S11) shown in FIG. 5.

The display screen shown in FIG. 14 shows a case in which the symbols of “seven”, “triple BAR”, “double BAR”, and “cherry” are displayed on the additional symbol display section 24. Specifically, the display screen show a case in which symbol candidates for these symbols are determined in the symbol candidate determination processing (S43) shown in FIG. 8, and displayed on the additional symbol display section 24. It should be noted that in the additional symbol determination processing (S42) executed prior to the symbol candidate determination processing (S43), the symbol of “seven” is determined as an additional symbol.

In the display example shown in FIG. 14, in addition to the variable display sections 21 through 23 and the additional symbol display section 24, the operation keys (touch keys) corresponding to various buttons provided in the control panel 5 are displayed. Specifically, a CHANGE key 6′, a PAYOUT key 7′, a HELP key 8′, a 1-BET key 11′, a 3-BET key 13′, a 5-BET key 14′, and a SPIN (SPIN/REPEAT BET) key 12′ are provided. Various operations can be performed by the player with these operation keys as well.

In a state in which such a display screen is displayed in the lower liquid crystal display 4, the symbol combination determination processing (S33) is performed in accordance with the random numbers extracted in the random number extraction processing (S32) shown in FIG. 7A. Here, the symbol combination determined in the combination determination processing (S33) is a symbol combination “all seven”. In this case, in the subsequent stopped symbol determination processing (S34), the CPU 50, in consideration of blank symbols, determines a symbol to be stopped and displayed on the active pay line L for each of the variable display sections 21 through 23, so that the symbol combination “all seven” is established.

Specifically, the symbol combination “all seven” may be configured by stopping and displaying only the symbol “seven” on the active pay line L, or may be configured by stopping and displaying a combination of the symbol “seven” and a blank symbol on the active pay line L. Here, the combination “all seven” is configured in the latter manner, and particularly, a blank symbol is stopped and displayed on the variable display section 21 while the symbol “seven” is stopped and displayed on both variable display sections 22 and 23.

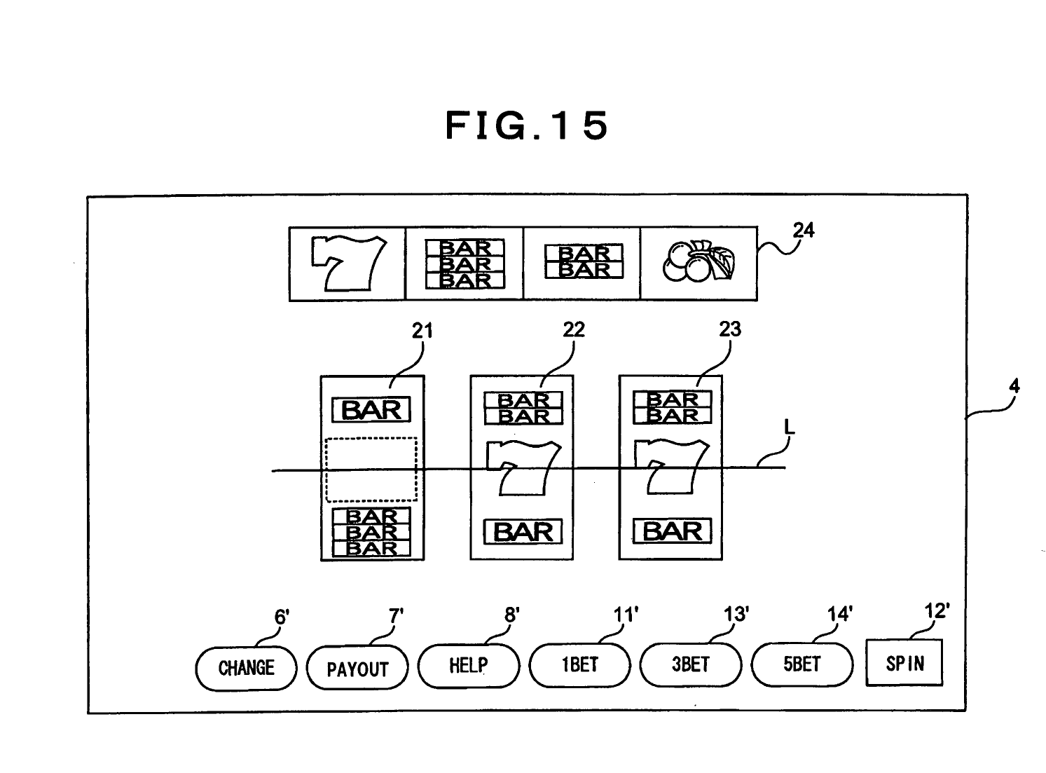

FIG. 15 shows an example of the display screen of the lower liquid crystal display 4 in a case in which the stopped symbol determined in the stopped symbol determination processing (S34) is stopped and displayed in the stop control processing (S52) of the basic game processing shown in FIG. 11. FIG. 15 shows a case in which a blank symbol is stopped and displayed on the variable display section 21, and the symbol “seven” is stopped and displayed on the both variable display sections 22 and 23, in accordance with the symbol determined in the stop control processing (S52) described above.

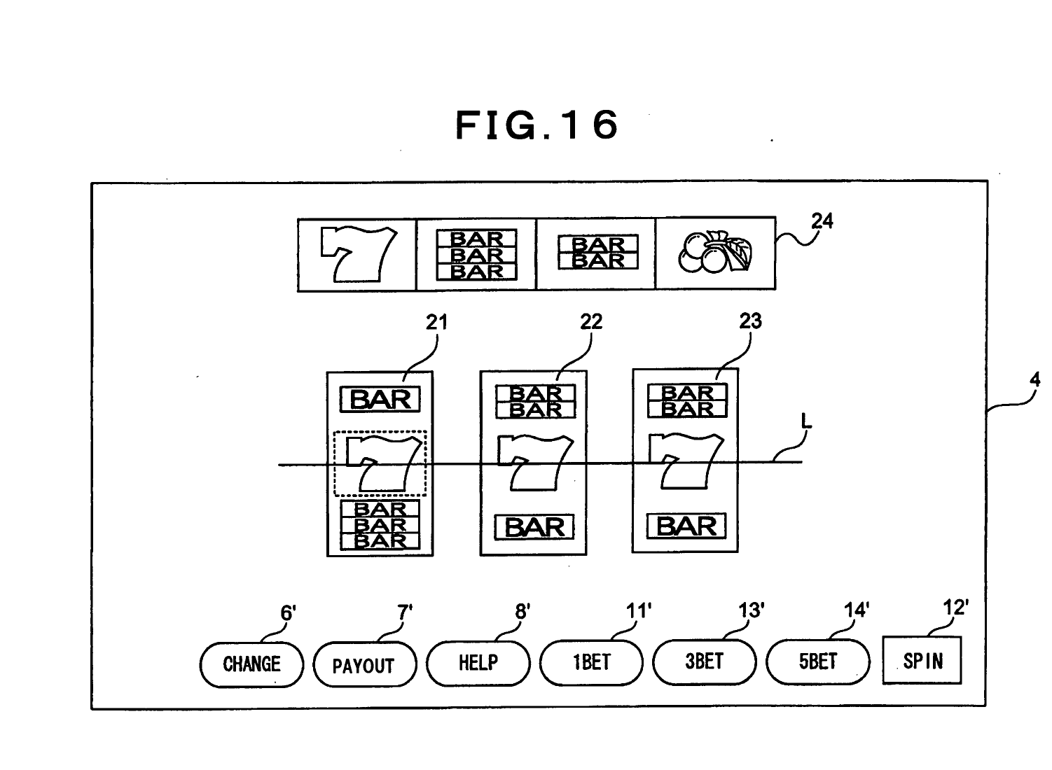

After the stopped symbols determined in the stopped symbol determination processing (S34) in the above manner are displayed on the variable display sections 21 through 23, the CPU 50 displays the additional symbol of “seven” on a blank symbol. FIG. 16 shows an example of the display screen of the lower liquid crystal display 4 in a case in which an additional symbol is displayed on the blank symbol which is stopped and displayed in the stop control processing (S52). By displaying the additional symbol “seven” on the blank symbol stopped and displayed in the stop control processing (S52), the symbols of “seven” are displayed in line on the active pay line L, and the symbol combination of “all seven” is established.

As described above, according to the slot machine 1 of the present embodiment, additional symbols which can be added and displayed on blank symbols during variable display in the variable display sections 21 through 23 are displayed on the lower liquid crystal display 4 (additional symbol display section 24), while, when displaying blank symbols on the variable display sections 21 through 23, additional symbols are added and displayed on these blank symbols. Accordingly, the player can recognize the additional symbols which are displayed on the blank symbols corresponding originally to the losing in a game. As a result, the player can be allowed to expect a profit from display of the additional symbols on the blank symbols, thus the gaming interest in the game can be increased by effectively utilizing the effects in which the blank symbols are used.

Moreover, in the above slot machine 1, when the lower liquid crystal display 4 (additional symbol display section 24) is caused to display a plurality of additional symbols, and when the variable display sections 21 through 23 are caused to display blank symbols, any of the plurality of additional symbols is displayed on the blank symbol. Accordingly, sine any of the plurality of additional symbols displayed on the lower liquid crystal display 4 (additional symbol display section 24) is displayed on the blank symbol, the player can be given a sense of expectancy by the number of additional symbols to be displayed on the lower liquid crystal display 4 (additional symbol display section 24).

In the above slot machine 1, the type of the additional symbol can be changed. Accordingly, for example, since the type of the additional symbol can be changed for each game, thus the player can be given a different type of sense of expectancy for each game.

In the above slot machine 1, the type of the additional symbol is determined before variable display is started by the variable display sections 21 through 23, and is displayed on the lower liquid crystal display 4 (additional symbol display section 24). Accordingly, the player can recognize the additional symbols to be displayed on the blank symbols prior to the start of variable display, thus the player can be given a sense of expectancy from the initial stage of the game.

In the slot machine 1 according to the present embodiment, the additional symbols are symbols included in the plurality of symbols displayed on the variable display sections 21 through 23. Accordingly, the player can be allowed to expect that a winning combination, which partially has the additional symbol displayed on the blank symbol, is established.

It should be noted that the present invention is not limited to the above embodiment but can be modified in various ways without departing from the scope of the invention. In the above embodiment, the sizes or forms illustrated in the attached drawings are not limited to those illustrated in the drawings, but can be changed appropriately within the scope where the effects of the present invention are produced. Moreover, the present invention can be changed appropriately and implemented without departing from the scope of the objects of the present invention. Modified examples of the present invention are illustrated hereinafter.

The above slot machine 1 shows a case in which the symbols which are variably displayed on the variable display sections 21 through 23 (symbols of “seven”, “triple BAR”, and the like) are displayed as the additional symbols on the blank symbols. However, the symbols to be displayed on the blank symbols can be changed appropriately. For example, there may be displayed symbols for providing a predetermined award (for example, paying out the gaming medium such as coins) (referred to as “award symbol” accordingly, hereinafter) to the player independently of the symbol combination constituted by a combination of symbols displayed on the active pay line L.

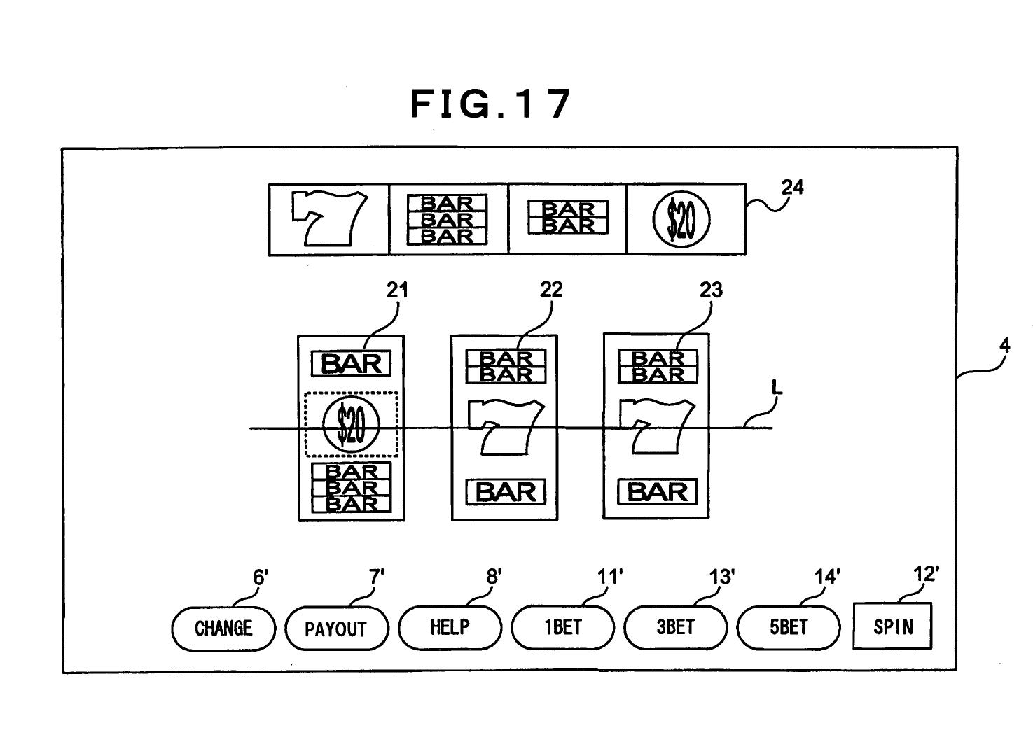

FIG. 17 shows an example of the display screen of the lower liquid crystal display 4 in a case in which the award symbols as the additional symbols are displayed on the blank symbols. FIG. 17 shows a case in which the award symbols are displayed on the symbol candidate display section 24 and an award symbol (in this case, an award symbol in which twenty coins are paid out) is displayed on the blank symbol stopped and displayed on the variable display section 21. In this manner, when the award symbols are displayed on the active pay line L, the CPU 50 pays out the gaming medium corresponding to the award symbols, such as coins, to the player.

As described above, in the case where the additional symbol is the award symbol for providing a predetermined award to the player when this additional symbol is added and displayed on the blank symbol, the player can be allowed to expect the predetermined award from the award symbol displayed independently of the display patterns of other various display sections 21 through 23.

Furthermore, the above slot machine 1 shows a case in which four symbol candidates are displayed on the additional symbol display section 24. However, the number of symbol candidates to be displayed on the additional symbol display section 24 can be changed appropriately. Specifically, three or less symbol candidates may be displayed, or five or more symbol candidates may be displayed. The number of symbol candidate may be variable. Changing the number of symbol candidates in this manner can be realized by, for example, registering the symbol candidates, including the number of symbol candidates to be displayed, in the symbol candidate table. It should be noted in this case that the symbol candidates do not have to be displayed. As in the case where the type of the additional symbol is made variable, in this case as well the number of additional symbols can be changed for each game, thus the player can be given a different type of sense of expectancy for each game.

Moreover, the above slot machine 1 shows a case in which the additional symbols and the symbol candidates are determined in the additional symbol lottery processing (S31) shown in FIG. 7. However, the timing for determining the additional symbols and symbol candidates can be changed appropriately. For example, the additional symbols and the symbol candidates may be determined at different timing. Specifically, the symbol candidates may be determined at the same timing as in the above embodiment, and the additional symbols may be determined from the symbol candidates when the blank symbols are displayed as a result of the stopped symbol determination processing (FIG. 7A: S34). In this case as well, the gaming interest in a game can be increased by effectively utilizing the effects in which the blank symbols are used, as in the above embodiment.

In addition, the above slot machine 1 shows a case in which the additional symbols are displayed after the blank symbols on the variable display sections 21 through 23 are stopped and displayed on the active pay line L. However, the display patterns of the additional symbols can be changed appropriately. For example, the additional symbols may be rotated along with the blank symbols on the variable display sections 21 through 23. In this case, the symbol candidates to be displayed on the additional symbol display section 24 may be displayed randomly. When making such a change, either the additional symbols or the symbol candidates are displayed instead of the blank symbols during variable display is performed on the variable display sections 21 through 23, thus the expectations of the player can be increased.

Further, the above slot machine 1 shows a so-called vide-reel slot machine, but the present invention can be applied to a slot machine in which a so-called mechanical reel is used instead of a video reel. In this case, for example, such a slot machine can be realized by displaying additional symbols on the position of the lower liquid crystal display 4, which corresponds to the mechanical reel in which blank symbols are stopped on the active pay line L.

The above slot machine 1 shows the slot machine 1 in which the lower liquid crystal display 4 is provided with the three variable display sections 21 through 23 and a single active pay line L is set, but the number of variable display sections and the number of active pay lines L can be set arbitrarily. The above embodiment shows the case in which the stopped symbols on the three variable display sections 21 through 23 are determined by means of a single random number, but a single random number may be sampled for each of the variable display sections 21 through 23 to determine a stopped symbol on each of the variable display sections 21 through 23.

Further, the above slot machine 1 describes that coins are used as an example of the gaming medium, but the form of the gaming medium is not limited to coins, thus any forms such as medals, tokens and the like, may be taken as long as games can be played on the slot machine 1. Particularly, when receiving payout of the gaming medium acquired in a game, a magnetic card on which the number of acquired gaming media is recorded or a sheet on which the number of gaming media is printed may be used to receive payout. Further, the number of gaming media to be paid out may be managed in a server which manages the information in the slot machine 1.

The lottery performed in the above slot machine 1 (lottery performed in the additional symbol lottery processing or the lottery processing, for example) shows the case in which the additional symbol table in which is described the relationship between a random number and an additional symbol, or the lottery table in which is described the relationship between a random number and a winning combination are used. However, the contents of the lottery are not limited to this case but can be changed appropriately. Particularly, with regard to the registration contents in the lottery table, the random number and the winning combination may be associated with each other one-on-one, or a plurality of random numbers and a winning combination may be associated with each other or vice versa. Furthermore, instead of the relationship between a random number and a winning combination, the relationship between a random number and a symbol displayed variably on the variable display section may be described to determine a symbol which is stopped at each variable display section. In this case, use of the code numbers allocated respectively for the symbols is considered. In addition, instead of directly using a random number used for a lottery, a winning combination may be determined in accordance with a result of computation which is obtained by subjecting this random number in the computation processing.

As described above, in the first embodiment, the display means is caused to display the additional symbols which can be added and displayed on the blank symbols during variable display on the variable display sections, and when the blank symbols are displayed on the variable display sections, the additional symbols are added and displayed on the blank symbols, thus the gaming interest in the game can be increased by effectively utilizing the effects in which the blank symbols are used.

### Second Embodiment

FIG. 1B is a perspective view showing an external configuration of a slot machine which is a gaming machine according to a second embodiment. In FIG. 1B, the slot machine 201 has a cabinet 202 which forms the whole of the slot machine, wherein a lamp 220 is disposed on an upper part on the top surface of the cabinet 202. Further, an upper liquid crystal display 203 is disposed on an upper part of the front surface of the cabinet 202, and a lower liquid crystal display 204 which functions as display means is disposed on a central part of the front surface of the cabinet 202.

The upper liquid crystal display 203 is configured from a liquid crystal display which is used in general, and displays information on a game, such as a game method, a type of a winning combination and its award, and various effects related to the game. The lower liquid crystal display 204 is configured from a so-called transparent liquid crystal display, wherein three variable display windows 221 through 223 and variable display windows 224 through 226 are formed, as shown in FIG. 1B. The variable display windows 224 through 226 are smaller than the variable display windows 221 through 223 and formed at an end portion in the lower liquid crystal display 204 (lower end portion on the right side in FIG. 1B).

As described in detail hereinafter, the variable display windows 221 through 223 are used in the basic game equivalent to the first game, while the variable display windows 224 through 226 are used in the bonus game equivalent to the second game. Here, the second game is various games performed in addition to the basic game, and includes a game (for example, a bonus game described hereinafter) performed in a gaming state which is different from that of the basic game.

In the second embodiment, one active pay line L1 is provided on the variable display windows 221 through 223, while one active pay line L2 are provided on the variable display windows 224 through 226. In each of the variable display windows 221 through 223 and each of the variable display windows 224 through 226, aftermentioned various symbols formed in a reel are displayed while scrolling from top to bottom.

Furthermore, on the lower liquid crystal display 204, there are displayed various effects and the like related to a game, as in the case upper liquid crystal display 203. Hereinafter, description of the detail of the configuration of the slot machine is omitted since it overlaps with the description in the first embodiment.

It should be noted that three reels serving as first variable display means are disposed on positions in the vicinity of the three variable display windows 221 through 223 formed in the lower liquid crystal display 204. Out of the three reels, the left reel, which is positioned on the left side when viewed from the front of the slot machine 201, faces the variable display window 221 formed in the lower liquid crystal display 204, the center reel similarly faces the variable display window 222, and the right reel similarly faces the variable display window 223.

Moreover, three reels serving as second variable display means are disposed on positions in the vicinity of the three variable display windows 224 through 226. Out of the three reels, the left reel, which is positioned on the left side when viewed from the front of the slot machine 201, faces the variable display window 224 formed in the lower liquid crystal display 204, the center reel similarly faces the variable display window 225, and the right reel similarly faces the variable display window 226.

Various symbols which are used in the basic game are formed on circumferential surfaces of the reels which are disposed in opposition to the variable display windows 221 through 223 respectively. On the other hand, various symbols which are used in the bonus game are formed on circumferential surfaces of the reels which are disposed in opposition to the variable display windows 224 through 226 respectively.

Here, FIG. 2 is used to describe examples of the symbols which are variably displayed while scrolling on the variable display windows 221 through 223 and variable display windows 224 through 226 of the lower liquid crystal display 204. FIG. 2 is a figure showing examples of symbol columns which are displayed variably while scrolling on the variable display windows 221 through 223 of the lower liquid crystal display 204. In FIG. 2, a symbol column 141 is a symbol column displayed variably on the variable display window 221, a symbol column 142 is a symbol column displayed variably on the variably display window 222, and a symbol column 143 is a symbol column displayed variably on the variable display window 223.

The symbol columns 141 and 142 have an identical symbol arrangement, and each of these symbol columns is constituted by eleven symbols comprising appropriate combinations of a triple BAR 91, a cherry 92, a double BAR 93, a seven 94, a single BAR 95, and a blank (a region in which no symbol exists) 96.

The symbol column 143 is different from the symbol columns 141 and 142 in that, in addition to the symbols included in the symbol columns 141 and 142, a single trigger symbol 97 is arranged. The trigger symbol 97 is a symbol for advancing to a bonus game which is described hereinafter, and thus when the trigger symbol 97 is stopped and displayed on the active pay line L1 in the variable display window 223, the gaming state advances to the bonus game.

When forming various symbols on the circumferential surface of each of the reels, a typical method involves printing eleven symbols on an elongated reel sheet which matches the width and circumference of the each of the reels, and adhering the reel sheet to the peripheral surface of each reel. However, it goes without saying that another method may be employed to form the symbols.

It should be noted that when each of the scrolling symbol columns 141 through 143 is stopped and displayed in each of the variable display windows 221 through 223, three symbols are stopped and displayed on the active pay line L1. Moreover, various winning combinations are set beforehand on the basis of a plurality of symbol combinations, and when a symbol combination corresponding to a winning combination stops on the active pay line L1, coins are paid out from the coin payout opening 215 in accordance with the winning combination. This point is similar to a conventional slot machine, and thus further description is omitted here.

In the variable display windows 224 through 226 as well, the symbol columns shown in FIG. 2 are variably displayed while scrolling. In this case, for example, the symbol column 141 (or symbol column 142) shown in FIG. 2 is variably displayed on each of the variable display windows 224 through 226. Specifically, the trigger symbol 97 does not appear in the variable display windows 224 through 226.

Next, the configuration of the control system of the slot machine 201 is described on the basis of FIG. 3B, but descriptions of the sections which overlap with those in the first embodiment are omitted.

Here, a motor drive circuit 367A for performing drive control of reels 420A disposed in opposition to the variable display windows 221 through 223, a stepping moor 268A, a position change detection circuit 269A, a motor drive circuit 367B for performing drive control of reels 420B disposed in opposition to the variable display windows 224 through 226, a stepping moor 268B, and a position change detection circuit 269B are connected to a CPU 250. The both motor drive circuits 367, stepping motors 268, and position change detection circuits 269 are controlled in the similar manner, thus description of the former components are provided but description of the latter components are omitted.

When a motor drive signal (command pulse) is output from the CPU 250 to the motor drive circuit 367A, each of the stepping motors 268A is rotary driven by an excitation signal which is output from the motor drive circuit 367A. The CPU 250 counts the number of drive pulses supplied to the stepping motors 268A to recognize the position of rotation of a symbol in each of the reels 420A on the basis of the counted number of pulses, and further performs stop position control and the like.

The position change detection circuit 269A detects change of the stop positions of the reels 420A after stop control is performed by the motor drive circuit 367A. For example, the position change detection circuit 269A detects the stop positions of the reels 420A, when the stop positions are changed so that a combination of stopped symbols is forcibly obtained as a winning combination by the player, although this combination of stop symbols is not actually the winning combination. The position change detection circuit 269A is configured so as to be capable of detecting change of the stop position of each reel 420A by, for example, detecting fins attached to the inner part of the reel 420A at predetermined intervals.

It should be noted that in FIG. 4, a program ROM 81 stores an image control program and various selection tables related to the display on the upper liquid crystal display 203 or lower liquid crystal display 204. An image ROM 82 stores dot data and the like for forming images by means of the upper liquid crystal display 203 or lower liquid crystal display 204. An image control CPU 83 determines an image to be displayed on the upper liquid crystal display 203 or lower liquid crystal display 204 from among the dot data stored beforehand in the image ROM 82 on the basis of parameters set by the CPU 250 and in accordance with an image control program stored beforehand in the program ROM 81. A work RAM 84 is configured as temporary storage means when the image control program is executed by the image control CPU 83. A VDP 85 creates image data corresponding to the display content determined by the image control CPU 83, and outputs the image data to the upper liquid crystal display 203 or lower liquid crystal display 204. It should be noted that the video RAM 86 is configured as temporary storage means when an image is formed by the VDP 85.

Next, an operation example of the slot machine 201 of the second embodiment, which has the above configurations, is described. However, descriptions of the sections which overlap with those in the first embodiment are omitted.

It should be noted that in the slot machine 201 of the present embodiment, the variable display windows 221 through 223 are used in the basic game, while the variable display windows 224 through 226 are used in the bonus game.

Specifically, in the basic game, the variable display windows 221 through 223 are brought into a visible state so that the reels 420A inside the cabinet 202 are viewed by the player. On the other hand, the variable display windows 224 through 226 are configured such that the image data is displayed on a corresponding part so that the reels 420B inside the cabinet 202 cannot be viewed by the player. Further, in the bonus game the variable display windows 224 through 226 are brought into a visible state so that the reels 420B inside the cabinet 202 can be viewed by the player. On the other hand, the variable display windows 221 through 223 are configured such that the image data is displayed on a corresponding part so that the reels 420A inside the cabinet 202 cannot be viewed by the player.

Next, the lottery processing (S12) performed in the slot machine 201 of the second embodiment is described on the basis of FIG. 7B. FIG. 7B is a flowchart showing an example of the lottery processing. When comparing with the lottery processing of the first embodiment described using FIG. 7A, the present flowchart of the lottery processing does not have the step of the additional symbol lottery processing (S31), and other steps (S131 through S133) are the similar steps of the processing.

It should be noted in FIG. 7B, that, subsequent to the symbol combination determination processing (S132), the CPU 250 executes stopped symbol determination processing (S133). In this stopped symbol determination processing, a symbol stopped and displayed on the active pay line L1 is determined for each of the variable display windows 221 through 223 so that the symbol combination determined in the symbol combination determination processing is established. Specifically, the CPU 250 determines a code number of the stopped symbol so that a combination of symbols corresponding to the determined symbol combination is established on the active pay line L1. Then, after the stopped symbol determination processing (S133) is ended, the step is returned to the main processing shown in FIG. 5 and then processed to the basic game processing of S13.

Next, the basic game processing (S13) performed in the slot machine 201 of the second embodiment is described on the basis of FIG. 11. FIG. 11 is a flowchart showing an example of the basic game processing. In S13 of the main processing shown in FIG. 5, the CPU 250 first executes rotation processing (S51) to start the rotation of the three reels 420A inside the cabinet 202 on the basis of the switch signal which is output from the SPIN switch 258, 1-BET switch 259, 3-BET switch 260, or 5-BET switch 261 and received in the start reception processing (S11). Through this rotation processing, each symbol is scrolled in each of the variable display windows 221 through 223. At this moment, since the variable display windows 221 through 223 are in the visible state, the scrolling symbols can be viewed.

Next, the CPU 250 executes stop control processing (S52) to stop the rotation of the three reels 420A inside the cabinet 202 in order to stop the stopped symbol determined in the lottery processing (S12) on the active pay line L1, more specifically in the stopped symbol determination processing (S133) shown in FIG. 7B. Through this stop control processing, scrolling of each symbol in each of the variable display windows 221 through 223 is stopped.

Next, the CPU 250 executes addition computation processing (S53) for temporarily adding the value of coins equivalent to the award which is set beforehand, in accordance with the combination of symbols stopped and displayed on the variable display windows 221 through 223 in the stop control processing (S52). It should be noted that these coins to be paid out are allocated and stored in a fixed region in the RAM 252. In this addition computation processing, coins and the like are added in accordance with the symbol combination determined in the abovementioned combination determination processing (S132). It should be noted that after the addition computation processing is executed, the CPU 250 returns to the main processing shown in FIG. 5. During the basic game processing is carried out in this manner, the positions corresponding to the variable display windows 224 through 226 are used as the display regions for displaying the effects, and the reels 420B inside the cabinet 202 cannot be viewed by the player.

Returning to FIG. 5, more explanation of the main processing is continued. After the basic game processing (S13) is executed, the CPU 250 determines whether or not the bonus game is established (S14). This determination is made on the basis of the symbols stopped on the active pay line L1 in the stop control processing (S52) in the basic game processing shown in FIG. 11, or on the basis of the random number or symbol combination determined in the lottery processing (S12).

When it is determined that the bonus game is established (S14: Yes), the CPU 250 executes the bonus game processing (S15). In the bonus game processing (S15), the slot machine 201 executes a free game in which the predetermined number (10 in the second embodiment) of free spins are performed. Specifically, in the slot machine 201 of the second embodiment, the bonus game is same as the free game in which 10 free spins are allowed to be performed.

When performing free spins, processing similar to the basic game processing is performed without allowing the player to spend coins or other accumulated credits by inserting coins or pressing any bet buttons. Therefore, during the bonus game, payment with coins or credits can be received without consuming the coins or the number of credits, thus the player can enjoy an advantage that coins or credits can be acquired.

Hereinafter, the bonus game processing performed in the slot machine 201 is described on the basis of FIG. 12. FIG. 12 is a flowchart showing an example of the bonus game processing. In S15 of the main processing shown in FIG. 5, when the bonus game processing is started, the CPU 250 first executes free spin processing (S61).

Here, the free spin processing executed in the bonus game processing is described on the basis of FIG. 13. As shown in FIG. 13, when the free spin processing is started, the CPU 250 executes processing similar to the lottery processing (S12) and the basic game processing (S13) shown in FIG. 5 in accordance with a predetermined operation performed by the player, and thus performs lottery processing (S71) which is equivalent to the lottery processing (S12).

It should be noted that the lottery processing shown in S71 is different from the lottery processing (FIG. 5: S12) shown in FIG. 7B in that the lottery processing shown in S71 comprises the processing for determining an additional symbol (referred to as “additional symbol determination processing” hereinafter) to be added and displayed on a position corresponding to a symbol of “blank” (referred to as “blank symbol” accordingly hereinafter) on the lower liquid crystal display 204 when the blank symbol is stopped and displayed in the variable display windows 224 through 226.

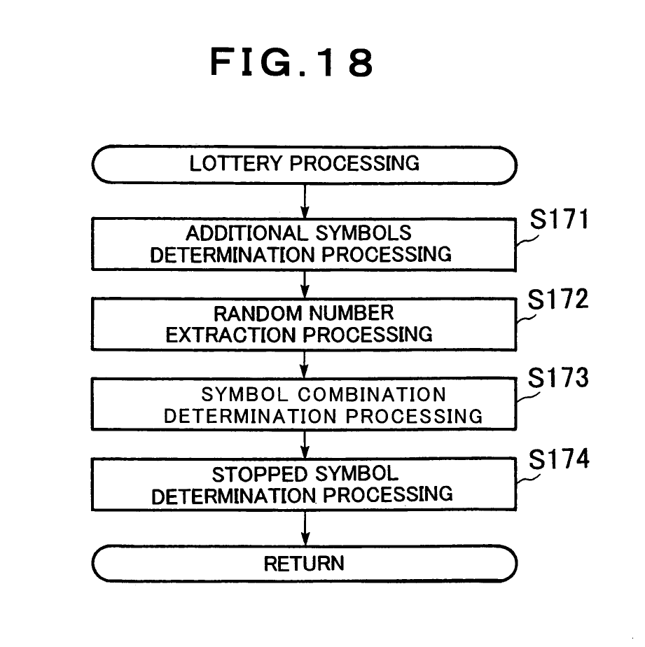

FIG. 18 is a flowchart showing an example of the lottery processing (S71) in the free spin processing shown in FIG. 13. When the lottery processing is started, the CPU 250 first performs the additional symbol determination processing (S171). In this additional symbol determination processing, a random number, which is extracted to determine an additional symbol, is compared with the additional symbol table in which is described the relationship between a random number and an additional symbol, whereby an additional symbol corresponding to the extracted random number is determined.

It should be noted that in this additional symbol table, for example, there are described a symbol of “seven” if the random number value is within a range of 1 through 5, a symbol of “triple BAR” if the random number value is within a range of 6 through 15, a symbol of “double BAR” if the random number value is within a range of 16 through 35, a symbol of “single BAR” if the random number value is within a range of 36 through 75, and a symbol of “cherry” if the random number value is within a range of 76 through 155.

After the additional symbol is determined in the additional symbol determination processing (S171), the CPU 250 proceeds to the subsequent random number extraction processing S172, and thereafter executes the symbol combination determination processing (S173) and the stopped symbol determination processing (S174). It should be noted that for the random number extraction processing (S172), symbol combination determination processing (S173), and stopped symbol determination processing (S174), processing similar to the lottery processing (FIG. 5: S12) shown in FIG. 7A is performed, thus explanations thereof are omitted.

Subsequent to the lottery processing (S71), the CPU 250 carries out symbol variable display starting processing (S72) equivalent to the rotation processing (S51) in the basic game processing shown in FIG. 11 and symbol variable display stopping processing (S73) equivalent to the stop control processing (S52). In this symbol variable display stopping processing, the CPU 250 stops variable display of each symbol on each of the variable display windows 224 through 226 so that the symbols determined in the lottery processing (S71) are displayed respectively on the variable display windows 224 through 226.

At this moment, when blank symbols are stopped on the active pay lines L2, the CPU 250 displays the additional symbols (image data of the additional symbols) determined in the previous additional symbol determination processing (S171), on the positions corresponding to the blank symbols in the lower liquid crystal display 204. Accordingly, the additional symbols displayed on the blank symbols can be viewed.

Next, when the stopped symbols displayed respectively on the variable display windows 224 through 226 include a combination of predetermined symbols, the CPU 250 performs winning determination processing (S74) for calculating the number of coins to be paid out to the player or the number of credits to be newly added to the number of credits having by the player. It should be noted that the timing for performing the winning determination processing can be changed appropriately, and can be performed at any timing after the bonus game processing is started and before the next payout processing (S16) is started.

In the winning determination processing (S74), after the number of coins or the like to be paid out to the player is calculated, the CPU 250 executes addition computation processing for temporarily adding the abovementioned number of coins to the coins to be paid out (S75). When the abovementioned steps S71 through S 75 are carried out, one free spin processing is completed.

Returning to FIG. 12, more explanation of the bonus game processing is continued. When the free spin processing is ended in the manner described above, the CPU 250 determines whether or not the number of executions of the free spin processing, which is a condition for ending the bonus game processing, reaches a prescribed number (10 in the second embodiment) (S62). If the number of executions of the free spin processing does not reach the prescribed number as a result of such determination (S62: No), the CPU 250 executes the free spin processing (S61) again. When, on the other hand, the prescribed number is reached (S62: Yes), the CPU 250 ends the bonus game processing and returns to the main processing. It should be noted that during the bonus game processing is carried out in this manner, the positions corresponding to the variable display windows 221 through 223 are used as the display regions for displaying the effects, and the reels 420A inside the cabinet 202 cannot be viewed by the player.

Returning to FIG. 5, more explanation of the main processing is continued. In S14, if the bonus game is not established (S14: No), and if the bonus game processing (S15) is ended, the CPU 250 carries out payout processing (S16) for ejecting, at once, the number of coins equivalent to the number of awards, which are added to the coins to be paid out in the addition computation processing (S53) of the basic game processing or in the addition computation processing (S75) of the free spin processing, or for newly adding the number of awards to the number of credits having by the player. After the payout processing is performed, the CPU 250 returns the processing to the start reception processing (S11) to prepare for the start of the next game. These are the explanations of the main processing and of examples of operations performed in the slot machine.

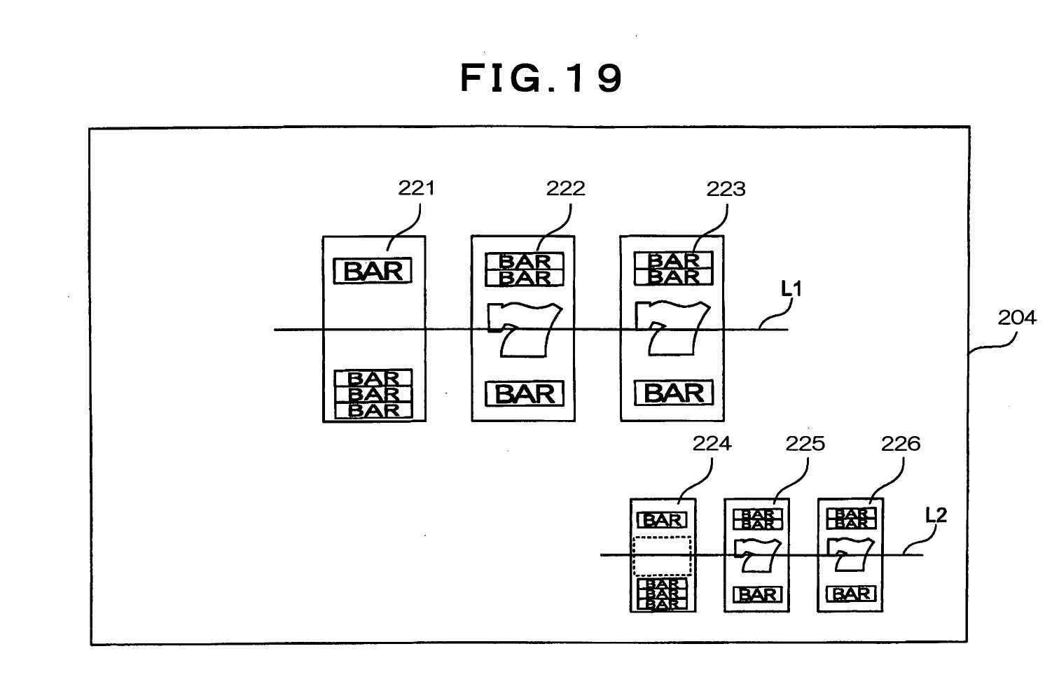

Hereinafter, an example of a display screen of the lower liquid crystal display 204 in each gaming state of the slot machine 201 related to the second embodiment is being executed is explained. FIG. 19 shows an example of the display screen of the lower liquid crystal display 204 in the initial state (a state in which no image data is displayed on the lower liquid crystal display 204). In this state, as shown in FIG. 19, the variable display windows 221 through 223 and the variable display windows 224 through 226 are in the visible state. For this reason, the symbols on the reels 420A and 420B inside the cabinet 202 can be viewed via the variable display windows 221 through 223 and the variable display windows 224 through 226.

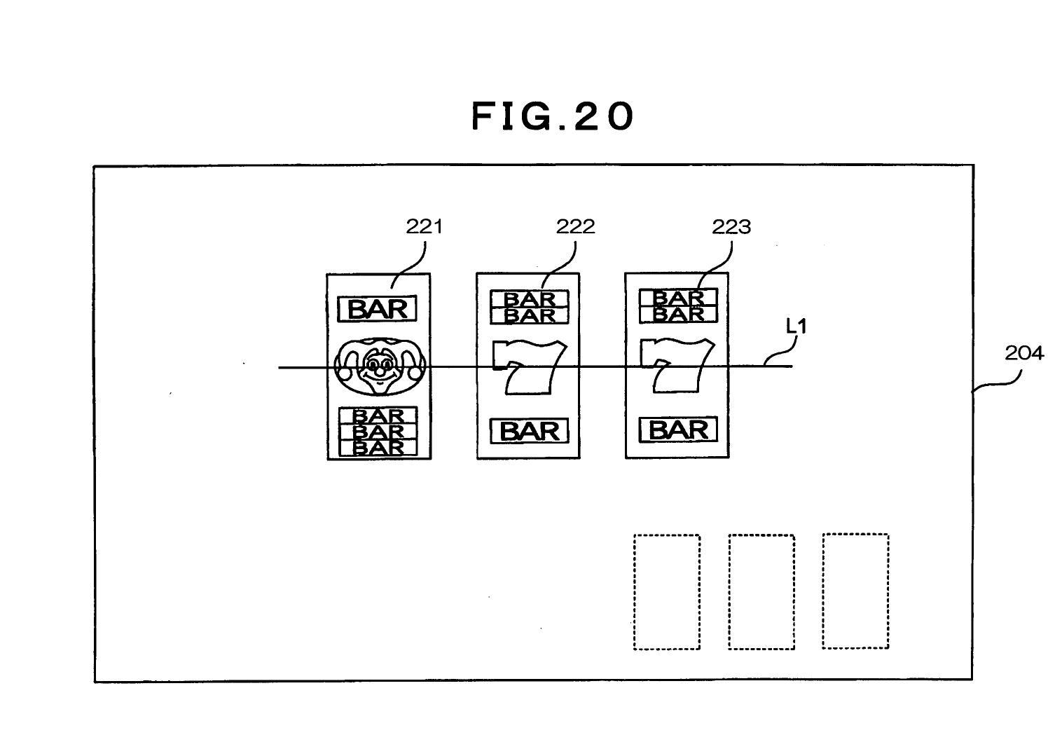

In the start reception processing (S11), if an instruction for starting a game is received from various switches, the processing proceeds to the lottery processing (S12) and then to the basic game processing (S13). As described above, in the basic game processing, the image data for effects is displayed on the positions corresponding to the variable display windows 224 through 226 in the lower liquid crystal display 204. FIG. 20 shows an example of the display screen of the lower liquid crystal display 204 when the basic game processing is being executed. In this state, as shown in FIG. 20, the variable display windows 221 through 223 are in the visible state, while the variable display windows 224 through 226 are in the invisible state. For this reason, the player can view only the symbols on the reels 420A inside the cabinet 202 via the variable display windows 221 through 223.

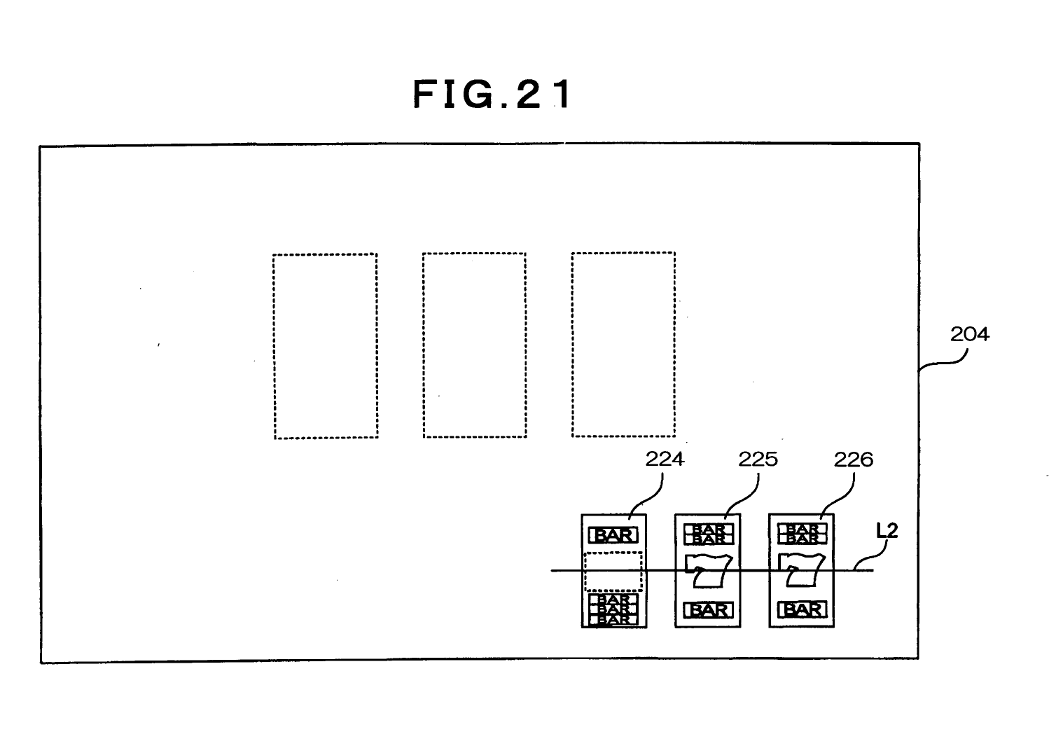

When the bonus game is established (S14: Yes) during execution of the basic game processing (S13), the processing proceeds to the bonus game processing (S15). In the bonus game processing, the image data for effects is displayed on the positions corresponding to the variable display windows 221 through 223 in the lower liquid crystal display 204. FIG. 21 shows an example of the display screen of the lower liquid crystal display 204 when the bonus game processing is being executed. In this state, as shown in FIG. 21, the variable display windows 224 through 226 are in the visible state, while the variable display windows 221 through 223 are in the invisible state. For this reason, the player can view only the symbols on the reels 420B inside the cabinet 202 via the variable display windows 224 through 226.

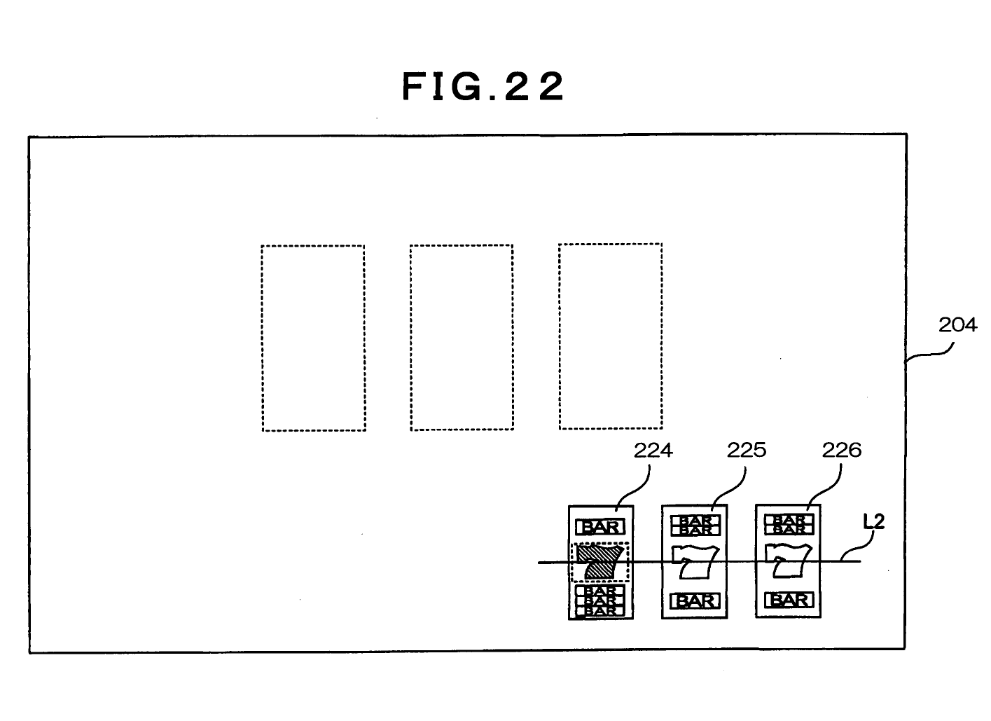

In such bonus game processing (S15), as shown in FIG. 21, when blank symbols are stopped and displayed on the active pay lines L2, the CPU 250 displays the additional symbols determined in the additional symbol determination processing of S171, on the positions corresponding to the blank symbols in the lower liquid crystal display 204. FIG. 22 shows an example of the display screen of the lower liquid crystal display 204 in which additional symbols are displayed on blank symbols when the bonus game processing is being executed. Here, a case in which the symbols of “seven” are displayed as the additional symbols is described. In this state, as shown in FIG. 22, the player can view the symbols on the reels 420B (symbols of “seven”) inside the cabinet 202 via the variable display windows 225 and 226, and can also view the additional symbols (symbols of “seven”) displayed on the positions corresponding to the blank symbols on the variable display window 224.

As described above, according to the slot machine 201 related to the second embodiment, when displaying blank symbols on the reels 420B used in the bonus game (sub-game), the CPU 250 displays any of the symbols on a position corresponding to the blank symbol in the lower liquid crystal display 204, thus the player can be allowed to expect a profit from display of other symbols on the blank symbols, thus the gaming interest in the bonus game (sub-game) can be increased.

Particularly, in the slot machine 201 of the second embodiment, the reels 420B used in the bonus game are disposed at the end portion (lower end portion on the right side) of the display region in the lower liquid crystal display 204. Therefore, the display region on the lower liquid crystal display 204, in which the variable display windows 224 through 226 are not disposed, can be used for displaying the effects, thus the gaming interest in the bonus game can be increased through this display of the effects.

Moreover, in the slot machine 201 of the second embodiment, the reels 420B used in the bonus game are made smaller than the reels 420A used in the basic game. Therefore, under a circumstance where the display region facing the player is limited, a space inside the cabinet 202 of the slot machine 201 can be efficiently utilized. It should be noted that in this case as well the present slot machine 201 displays other symbols on the positions corresponding to the blank symbols in the reels 420B used in the bonus game, thus the gaming interest in the bonus game can be increased while preventing a negative effect of reducing the size of the reels 420B.

It should be noted that the present invention is not limited to the above embodiment but can be modified in various ways without departing from the scope of the invention. In the above embodiment, the sizes or forms illustrated in the attached drawings are not limited to those illustrated in the drawings, but can be changed appropriately within the scope where the effects of the present invention are produced. Moreover, the present invention can be changed appropriately and implemented without departing from the scope of the objects of the present invention. Modified examples of the present invention are illustrated hereinafter.

For example, the above embodiment describes the case in which, when blank symbols are stopped and displayed on the variable display windows 224 through 226 during execution of the bonus game processing, other symbols on the reels 420B are displayed on positions corresponding to the blank symbols. However, as the embodiment, it is preferred that other candidates of symbols (referred to as “symbol candidate” hereinafter), which can be displayed on positions corresponding to the blank symbols, be displayed on the lower liquid crystal display 204, for the purpose of increasing the gaming interest of the player.

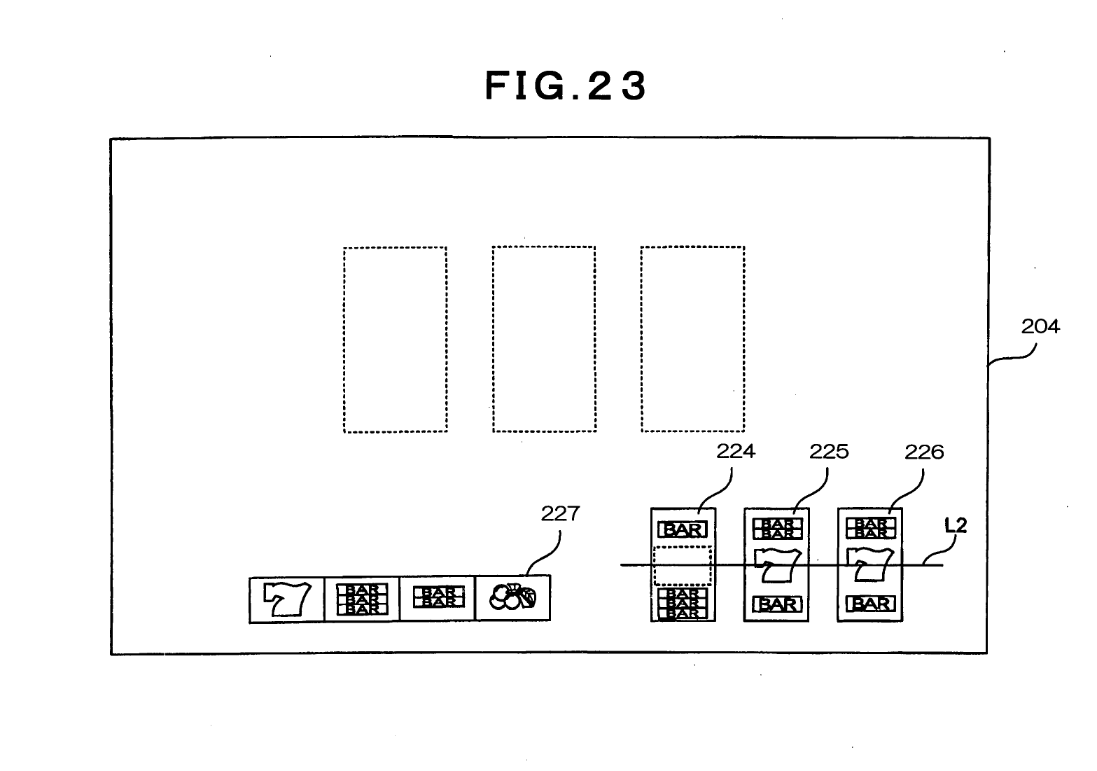

FIG. 23 shows an example of the display screen of the lower liquid crystal display 204 in a case where symbol candidates to be displayed on the positions corresponding to the blank symbols are displayed. The display screen shown in FIG. 23 shows a case in which the symbols of “seven”, “triple BAR”, “double BAR”, and “cherry” are displayed as the symbol candidates. As shown in FIG. 23, in the variable display windows 224, 225, and 226, in a state in which a blank symbol, “seven”, and “seven” are stopped and displayed on the active pay line L2, if the symbol of “seven” is determined as the additional symbols, a symbol combination, “all seven”, is established in the free game. When the symbol candidates, which can be displayed on positions corresponding to the blank symbols, are displayed in this manner, the player can be allowed to expect a profit when the additional symbols are displayed on the position corresponding to the blank symbols, thus the gaming interest in the game can be increased.

Further, the above slot machine 201 describes the slot machine 201 in which, in the lower liquid crystal display 204, the variable display windows 221 through 223 are provided and the active pay line L1 is set, and further the variable display windows 224 through 226 are provided and the active pay line L2 is set. However, the number of variable display windows and the number of active pay lines L can be set arbitrarily. The above embodiment shows the case in which the stopped symbols on the variable display windows 221 through 223 (variable display windows 224 through 226) are determined by a single random number, but a single random number may be sampled for each of the variable display windows 221 through 223 (variable display windows 224 through 226) to determine a stopped symbol on each of the variable display windows 221 through 223.

Further, the above slot machine 201 describes that coins are used as an example of the gaming medium, but the form of the gaming medium is not limited to coins, thus any forms such as medals, tokens and the like, may be taken as long as games can be played on the slot machine 1. Particularly, when receiving payout of the gaming medium acquired in a game, a magnetic card on which the number of acquired gaming media is recorded or a sheet on which the number of gaming media is printed may be used to receive payout. Further, the number of gaming media to be paid out may be managed in a server which manages the information in the slot machine 201.

The lottery performed in the above slot machine 201 (lottery performed in the additional symbol lottery processing or the lottery processing, for example) shows the case in which the additional symbol table in which is described the relationship between a random number and an additional symbol, or the lottery table in which is described the relationship between a random number and a winning combination are used. However, the contents of the lottery are not limited to this case but can be changed appropriately. Particularly, with regard to the registered contents in the lottery table, the random number and the winning combination may be associated with each other one-on-one, or a plurality of random numbers and a winning combination may be associated with each other or vice versa. Furthermore, instead of the relationship between a random number and a winning combination, the relationship between a random number and a symbol displayed variably on the variable display section may be described to determine a symbol which is stopped at each variable display section. In this case, use of the code numbers allocated respectively for the symbols is considered. In addition, instead of directly using a random number used for a lottery, a winning combination may be determined in accordance with a result of computation which is obtained by subjecting this random number in the computation processing.

As described above, in the second embodiment, when the blank symbols are displayed by means of the second variable display means used in the second game in addition to the first game, symbols which are different from the blank symbols are displayed on positions corresponding to the blank symbols, thus the gaming interest in the second game (sub-game) can be increased.

What is claimed is:

1. A gaming machine, comprising:
a display unit having a variable display section for variably displaying a plurality of symbols utilized in a game; and
a control unit for controlling the variable display on the variable display section;
wherein, when causing the variable display section to display at least one blank symbol, at least one symbol of a group of additional symbols, which are added and displayed on the at least one blank symbol included in the plurality of symbols at least during variable display performed by the variable display section, is added and displayed on the at least one blank symbol by the control unit.

2. A gaming machine, comprising:
a display unit having a variable display section for variably displaying a plurality of symbols utilized in a game; and
a control unit for controlling the variable display on the variable display section, wherein
the control unit causes the display unit to display an additional symbol, which is added and displayed on a blank symbol contained in the plurality of symbols, at least during the variable display performed by the variable display section when the blank symbol is displayed on the variable display section.

3. The gaming machine according to claim 2, wherein the control unit causes the display of a plurality of the additional symbols, and causes the display of any one of the plurality of additional symbols on the blank symbol when causing the variable display section to display the blank symbol.

4. The gaming machine according to claim 2, further comprising a plurality of additional symbols, wherein the control unit changes at least one of the identity of the additional symbol and the number of additional symbols.

5. The gaming machine according to claim 4, wherein the control unit determines at least one of the identity of the additional symbols and the number of additional symbols before variable display is started by the variable display section, and causes the display unit to display the additional symbols.

6. The gaming machine according to claim 2, wherein the additional symbol is a symbol included in the plurality of symbols displayed by the variable display section.

7. The gaming machine according to claim 2, wherein the additional symbol, which is being added and displayed on the blank symbol, is a symbol for providing a predetermined award to a player.

8. The gaming machine according to claim 2, wherein the variable display section comprises a transparent liquid crystal display.

9. The gaming machine according to claim 5, wherein determination of at least one of the identity of the additional symbol and the number of additional symbols is performed through random number lottery processing.

10. The gaming machine according to claim 7, wherein the symbol for providing the predetermined award is a symbol for paying out a predetermined number of coins.

11. A gaming machine, comprising:
a first variable display unit for variably displaying a plurality of symbols utilized in a first game;
a second variable display unit for variably displaying a plurality of symbols utilized in a second game which is played in addition to the first game;
a display unit disposed opposite the first and second variable display units and wherein the display unit displays at least one effect corresponding to a state of a game; and
a control unit for controlling the variable display performed by the first and second variable display units and the at least one effect displayed by the display unit,
wherein, when the second variable display unit displays a blank symbol included in the plurality of symbols, the control unit causes the display unit to display any symbol included in the plurality of symbols, on a position which corresponds to the blank symbol in the display unit.

12. The gaming machine according to claim 11, wherein the second variable display unit is disposed at an end portion of a display region.

13. The gaming machine according to claim 11, wherein a size of the second variable display unit is smaller than that of the first variable display unit.

14. The gaming machine according to claim 11, wherein the control unit causes the display unit to display an additional symbol which is displayed on a position which corresponds to the blank symbol in the second variable display unit.

15. The gaming machine according to claim 11, wherein the first variable display unit and the second variable display unit are reels in which a plurality of symbols are formed on circumferential surfaces thereof.

16. The gaming machine according to claim 11, wherein the display unit for displaying the effects is a liquid crystal display.

17. The gaming machine according to claim 11, wherein the first game is a basic game, and the second game is a bonus game.

18. The gaming machine according to claim 11, wherein, in the first game, the display unit for displaying the at least one effect is brought into a state so that the symbols displayed variably on the first variable display unit are viewed, and a state so that symbols displayed variably on the second variable display unit are not viewed.

19. The gaming machine according to claim 11, wherein, in the second game, the display unit for displaying the at least one effect is brought into a state so that the symbols displayed variably on the first variable display unit are not viewed, and a state so that the symbols displayed variably on the second variable display unit are viewed.

20. A gaming machine, comprising:
a slot game;
a plurality of reels for executing the slot game, where each reel has a plurality of symbols;
a group of additional symbols to be utilized in the slot game; and
a processor programmed to operate with the plurality of reels and the group of additional symbols to (a) enable a player to initiate the slot game by making a bet, (b) determine the group of additional symbols, (c) display the group of additional symbols while the plurality of reels are spinning, (d) superimpose a symbol of the group of additional symbols onto a blank symbol, if the blank symbol included in the plurality of symbols stops and displays with a predetermined combination of the plurality of symbols.

21. A gaming machine, comprising:
a basic game;
a first plurality of reels for executing the basic game, where each reel has a first plurality of symbols;
a bonus game;
a second plurality of reels for executing the bonus game, where each reel has a second plurality of symbols;
a group of additional symbols to be utilized in the bonus game; and
a processor programmed to operate with the first and second plurality of reels and the group of additional symbols to (a) enable a player to initiate the basic game by making a bet, (b) shift from the basic game to the bonus game, (c) determine the group of additional symbols, (d) display the group of additional symbols while the second plurality of reels are spinning, (e) superimpose a symbol of the group of additional symbols onto a blank symbol, if the blank symbol included in the second plurality of symbols stops and displays with a predetermined combination of the second plurality of symbols.
